(19) United States
(12) Patent Application Publication
(10) Pub. No.: US 2020/0394455 A1
(43) Pub. Date: Dec. 17, 2020

(54) DATA ANALYTICS ENGINE FOR DYNAMIC NETWORK-BASED RESOURCE-SHARING

(71) Applicants: Paul Lee, San Francisco, CA (US); Julian Okuyiga, San Francisco, CA (US); Nelson Estrada, San Francisco, CA (US)

(72) Inventors: Paul Lee, San Francisco, CA (US); Julian Okuyiga, San Francisco, CA (US); Nelson Estrada, San Francisco, CA (US)

(21) Appl. No.: 16/901,139

(22) Filed: Jun. 15, 2020

Related U.S. Application Data
(60) Provisional application No. 62/862,041, filed on Jun. 15, 2019.

(51) Int. Cl. G06K 9/62; G06N 20/00; G01C 21/34; G06Q 40/08

(52) U.S. Cl. CPC G06K 9/6232; G06K 9/6259; G06Q 40/08; G06N 20/00; G01C 21/3438; G06K 9/6267

(57) ABSTRACT

Systems and methods provide real-time machine learning modeling, evaluation, and visualization. A computing system can receive image data including a machine code from a client device. The system can decode the machine code to identify a user associated with the client. The system can retrieve a plurality of data sources associated with the user and a shared vehicle associated with the user. The system can extract a plurality of features from the plurality of data sources. The system can build a feature vector representing the plurality of features. The system can input the feature vector into a machine learner to identify a classification associated with the user. The system can generate a dynamic insurance policy for the user based on the classification.

### CROSS-REFERENCE TO RELATED APPLICATION

This patent application claims the benefit of U.S. Provisional Patent Application No. 62/862,041, filed Jun. 15, 2019, which is incorporated by reference herein in its entirety.

### TECHNICAL FIELD

The subject matter of the present disclosure generally relates to the field of big data analytics, and more particularly, to a data analytics engine for network-based distribution of the total or true cost of ownership of resources among multiple users.

### BACKGROUND

Determining the total or true cost of ownership (TCO) of a resource can be a data-intensive process requiring extensive utilization of computing resources (e.g., processing, memory, storage, network bandwidth, power, etc.) managed by an operations team for collecting and processing relevant data, accurate and robust modeling by expert data scientists for analyzing the data, and minimal or zero latency visualization of data analytics provided by user interface designers and engineers for users to quickly and intuitively understand the analysis of the data. Many users (e.g., corporations, organizations, individual persons, etc.) lack one or more of these technological capabilities and either forego this analysis or make do with substandard analytics. This can be a mistake. Failure to correctly assess the total or true cost of ownership at the outset of the development of a system may have larger negative effects downstream. Inattention to the total or true cost of ownership can also result in the misallocation of resources. In addition, ignoring or getting the total or true cost of ownership wrong can encourage or enable acts of moral hazard and free-riding. Optimizing the use of computing resources for the above-mentioned analysis operations presents many technical challenges. Further, generating and presenting an interactive user interface for a user to interact with such computing resources and data presents even further technical challenges.

### BRIEF DESCRIPTION OF THE DRAWINGS

Various ones of the appended drawings merely illustrate example examples of the present disclosure and cannot be considered as limiting its scope.

FIGS. 1A and 1B illustrate examples of various approaches for measuring a total or true cost of ownership of resources;

FIG. 2 illustrates a first example of a big data system in accordance with an embodiment;

FIG. 3 illustrates a second example of a big data system in accordance with an embodiment;

FIG. 4 illustrates an example of a data flow for a machine learning system in accordance with an embodiment;

FIGS. 5A-5F illustrate examples of graphical user interfaces to provide dynamic network-based resource-sharing services in accordance with an embodiment;

FIG. 6 illustrates an example of a process for providing dynamic network-based resource-sharing services in accordance with an embodiment;

FIG. 7 illustrates an example of a network environment in accordance with an embodiment;

FIG. 8 illustrates components of dynamic network-based resource-sharing services in accordance with an embodiment;

FIG. 9 illustrates an example of a software architecture in accordance with an embodiment; and

FIG. 10 illustrates an example of a computing device in accordance with an embodiment.

### DETAILED DESCRIPTION

Systems and methods in accordance with various examples may address some technical challenges in prior art approaches for accurately determining the total or true cost of ownership (TCO) and properly distributing resources according to TCO analysis. Various examples can involve dynamic or real-time machine learning (e.g., where dynamic or real-time can refer to operation with little to no noticeable delay by a user or operation exceeding a minimum threshold of latency). In some examples, a computing system of a network-based application service can receive image data, including a machine code from a client device. The computing system can decode the machine code to identify a user associated with the client device. The computing system can retrieve a plurality of data sources associated with the user and a shared vehicle associated with the user. The computing system can extract a plurality of features from the plurality of data sources. The computing system can build a feature vector representing the plurality of features. The computing system can input the feature vector into a machine learner to identify a classification associated with the user. The computing system can transmit a dynamic insurance policy for the user based on the classification.

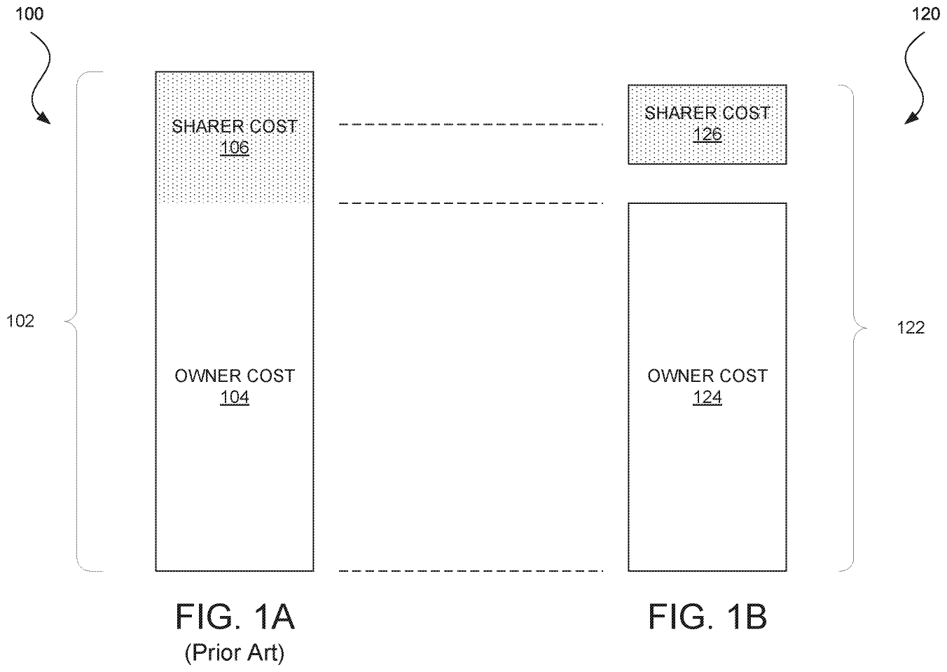

Turning now to the drawings, FIGS. 1A and 1B show different example approaches for determining the total and true cost of ownership of a resource (e.g., a motor vehicle) and how to allocate the cost between an owner of the resource and a party with whom the owner shares the resource (e.g., a borrower or sharer of the motor vehicle). For any system or system component discussed in the present disclosure, there can be additional, fewer, or alternative elements arranged in similar or alternative orders, or in parallel, within the scope of the various examples unless otherwise stated. In this example, FIG. 1A shows diagram of a conventional approach 100 for determining total cost of ownership 102 for an owner of a resource. For illustrative purposes, total cost of ownership 102 can represent the true cost of owning a vehicle and/or a personal auto insurance policy for the vehicle. This representation of TOC is equally applicable to a wide variety of contexts, such as computing (e.g., personal computing devices, enterprise software systems, data centers/private networks or clouds, public networks or clouds, etc.), transportation, buildings and facilities, and other types of insurance, among many other industries. As seen here, despite being directly responsible for only a portion (e.g., owner cost 104) of the cost of utilizing the resource, an owner of a vehicle bears the entirety of the responsibility of total cost of ownership 102. Sharer costs 106 in FIG. 1A represent amortized costs attributed to all “sharer costs” in a network. Specifically, there may be an assumption that the owner will share the resource with another party or parties (e.g., the sharers), and there may be additional assumptions that utilization by the sharers occurs under a worst-case scenario such that sharer cost 106 can be greater than expected. For example, in the vehicle ownership or personal auto insurance context, sharer cost 106 may be computed assuming that the sharer is a teenager who uses the vehicle for 3-5 occasions per week.

FIG. 1B shows diagram 120 of an example of an approach used in various examples for determining total cost of ownership 122. As seen here, total cost of ownership 122 may be apportioned between the owner and the sharer according to their respective usage of the resource, as opposed to the situation shown FIG. 1A were total cost of ownership 102 is carried by the owner. In the situation shown in FIG. 1B, the owner bears the owner cost 124, while the sharer (or sharers) bear the sharer cost 126, resulting in a more equitable distribution of the total cost of ownership. FIG. 1B also shows that sharer cost 126 can be less than sharer cost 106 because there may be more information collected to more accurately assess the cost of the sharer's utilization of the resource. For example, instead of assuming a worst-case scenario such as the sharer being a teen-aged driver, the sharer cost 126 may be evaluated to more accurately identify the sharer (e.g., a middle-aged, long-time driver who seldom borrows the vehicle).

In addition to reducing the total or true cost of ownership of a resource for both the owner in absolute cost and the sharer in relative cost, the example approach shown in FIG. 1B can also properly align behaviors and incentives. Instead of acting subject to moral hazard or free-riding, the approach of FIG. 1B encourages the sharer to make proper use of the resource because the sharer bears a portion of the cost proportional to the usage of the resource. Further, more resources can be devoted to accurately evaluate the sharer's behavior instead of allocated for speculating on the worst-case scenario. Various examples can provide these and other advantages over conventional systems by collecting new types of data not previously considered by the conventional systems, performing new analytical techniques beyond the capabilities of the conventional systems, and providing intuitive user interfaces that quickly achieve users' objectives.

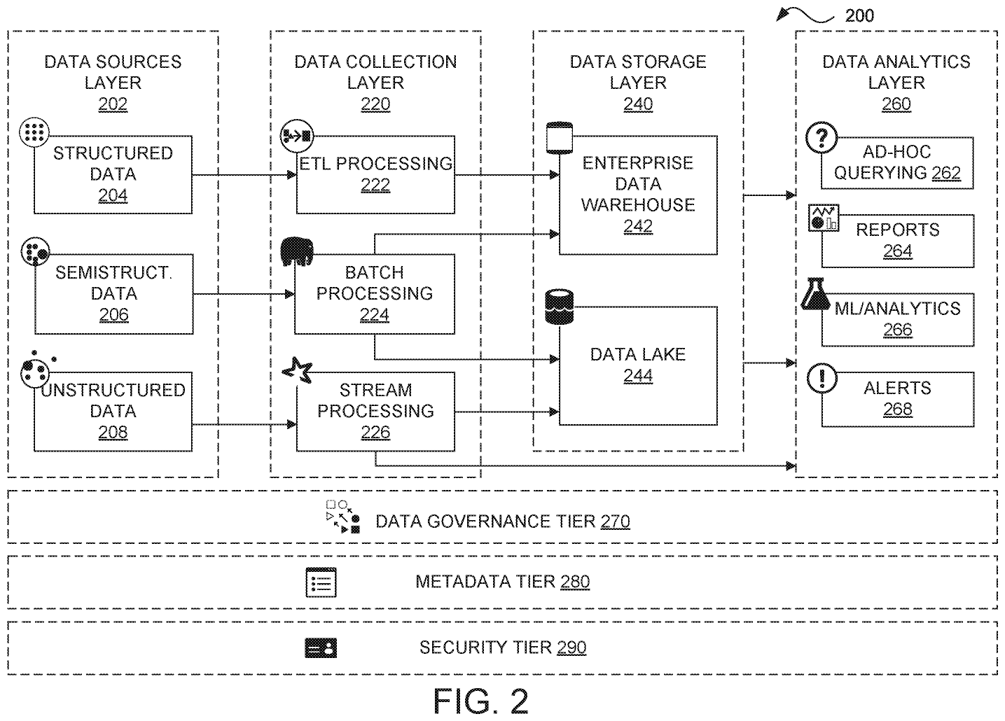

FIG. 2 shows an example of a “big data” architecture, data architecture 200, for supporting analysis of voluminous, high-velocity, and highly varied data. In general, the data architecture 200 can handle large volumes of data (e.g., terabytes or petabytes of data), receive data and transmit data at high velocities (e.g., near real-time or real-time, or without noticeable delay by a human user or not exceeding a minimum threshold of latency), and process a large variety of data, such as data having different structure (e.g., structured, semi-structured, unstructured, etc.), data of different types (e.g., text, audio, video, etc.), data associated with different data stores (e.g., relational databases, key-value stores, document databases, graph databases, column-family databases, data analytic stores, search engine databases, time-series databases, object store, file systems, etc.), data originating from different sources (e.g., enterprise systems, social networks, clickstreams, Internet of Things (IoT) devices, etc.), data having different rates of change (e.g., batch, streaming, etc.), or data having other heterogeneous characteristics.

Data architecture 200 shows one approach for conceptualizing heterogenous data and how a network may collect, process, store, and use the data. One of ordinary skill in the art will appreciate that other examples may conceptualize heterogeneous data along different dimensions (e.g., data type, type of data store, source, processing rate, etc.) and use alternative processing frameworks without departing from the scope of the present disclosure. In this example, data architecture 200 includes data source layer 202, data collection layer 220, data storage layer 240, data analytics layer 260, data governance tier 270, metadata management tier 280, and security management tier 290.

Data source layer 202 includes structured data 204, semi-structured data 206, and unstructured data 208. Structured data 204 is a type of data neatly arranged by delimiters or other formatting elements so that a computer can understand its structure. Structured data 204 can represent data entities that have a well-defined format and follow a predefined schema. Another aspect characterizing structured data 204 is that it may comprise a set of attributes having specific data types and/or other constraints such that data collection layer 220 can pre-allocate memory/storage upon ingestion (e.g., schema on write). Some examples of structured data 204 include data from enterprise systems and mainframes (e.g., accounting, billing, business intelligence, configuration management (CM), customer relationship management (CRM), enterprise asset management (EAM), enterprise resource planning (ERP), file system, supply chain management (SCM), etc.), online transactions processing (OLTP) systems, flat delimited files (e.g., comma-separated values (CSV)), and the like.

Semi-structured data 206 is similar to structured data 204 but includes fewer structural constraints. For instance, semi-structured data 206 can be loosely coupled to a schema and use the schema as general guidance for the structure of its data. However, the schema in semi-structured data 206 can vary from record to record. In some cases, semi-structured data 206 express complex relationships between data entities that cannot be intuitively represented using relational databases (e.g., records having random multi-nested fields, missing fields, different fields, similar fields associated with different data types, etc.). Examples of semi-structured data 206 include data stored or exchanged in formats such as Javascript Notation (JSON), Resource Description Framework (RDF), extensible mark-up language (XML), or other suitable standards or definitions; log data; or clickstream data; among other possibilities.

Unstructured data 208 generally includes information that may not conform to a particular structure or data model. Unstructured data 208 is often haphazardly organized such that it may be difficult for a computer to parse or separate into fields consistently found in each record of the data. Some examples of unstructured data 208 include the content of e-mails, Short Message Service (SMS) texts, instant messenger messages or chat transcripts, social network data, collaboration data, speech-to-text transcripts, video conference files, audio files, voicemails, and other electronic communications; word processing documents, spreadsheets, presentations, and other office documents; machine-generated data, such as Radio-frequency identification (RFID) data, Internet of Things (IoT) data, instrumentation/sensor data, event logs, file system information, configuration data, UNIX®/LINUX® data (e.g., output of PS, IOSTAT, and TOP utilities) and similar machine status data, virtualization data (e.g., hypervisor, guest operating system, virtual machine, container data, etc.), cloud data (e.g., provisioned computing, memory, storage, and network instance data), network telemetry (e.g., network flow data, web visitor logs,), or other information generated by machines; images, audio files, videos, or other media and multimedia files; or any other machine-readable data whose contents may not adhere to a particular format.

Data collection layer 220 includes extract, transform, and load (ETL) processing framework 222, batch processing framework 224, and stream processing framework 226. ETL processing framework 222 includes enterprise systems for extracting (primarily structured) data, transforming the extracted data for storage in the proper format, and loading the transformed data into a target ETL data sink in data storage layer 240. The ETL data sink includes enterprise data warehouse (EDW) 242, data marts (e.g., a data store representing a subset of the data of EDW 242), operational data stores (ODS) (e.g., a data store whose contents comprise additionally processed data from a subset of EDW 242, enterprise data management (EDM) or master data management (MDM) systems (e.g., Teradata®, Talend®, SAS®, etc.). In some examples, data collection layer 220 may not include ETL processing framework 222. Instead, data collection layer 220 can integrate ingestion of data, such as by having stream processing framework 226 (e.g., Apache Fl Ink®, Apache Samza™, Apache Spark™ Streaming, Apache Storm™, etc.) collect near real-time or real-time data (e.g., data received at a rate exceeding a minimum latency threshold) and batch processing framework 224 (e.g., Apache Hadoop® MapReduce) processing other enterprise system data. In still other examples, data collection layer 220 may not segregate data as batch data or streaming data. Instead, data collection layer may use a unified distributive processing framework for inputting all or substantially all data from data source layer 202 (e.g., a massively parallel processing (MPP) framework, a MapReduce framework, a Spark™ framework, etc.).

An MPP framework coordinates processing of an application using multiple processors (e.g., upwards of 200 or more) that work on different portions of the application. Each processor may use its own operating system and memory (e.g., share-nothing). MPP processors can communicate with one another using a messaging interface in an “interconnect” configuration of data paths.

The MapReduce framework is a scalable fault-tolerant system for processing large datasets across a cluster of commodity servers. The MapReduce framework includes a cluster manager (e.g., Apache Hadoop® Yet Another Resource Negotiator (YARN)), a distributed file system (e.g., HDFS™), and a distributed compute engine (e.g., MapReduce).

YARN is a cluster management framework that includes a cluster manager (one per cluster), one or more ApplicationMaster(s) (one per application that can span across several nodes of the cluster) that provide job scheduling and monitoring functionality for each application, and one or more containers per node. The YARN cluster manager comprises a NodeManager (one per node) that operates as a slave for managing the processing resources of a cluster and a ResourceManager (one per cluster) that operates as a master for managing the NodeManager slaves. The ResourceManager includes an ApplicationsManager for accepting jobs from a client application and assigning the first container for running the ApplicationMaster. The Scheduler allocates cluster resources to the ApplicationMaster for running jobs.

The NodeManager manages the resources available on a single node. It reports these resources to the ResourceManager. The ResourceManager manages resources available across the nodes in the cluster, pools together the resources reported by the NodeManagers, and allocates the resources to different applications.

The ApplicationMaster is generally provided by a distributive processing framework (e.g., Spark™, MapReduce, etc.). The ApplicationMaster owns and executes a job on a YARN cluster, negotiates resources with the ResourceManager, and works with the NodeManagers to execute a job using containers. The ApplicationMaster also monitors jobs and tracks progress. Containers represent the resources available to an application on a single node. The ApplicationMaster obtains the containers required to execute a job with the ResourceManager. On successful allocation, the ApplicationMaster launches containers on the cluster nodes working with the NodeManagers.

HDFS™ is a distributed file system that stores data across a cluster of commodity servers (e.g., general-purpose computers that are standardized, readily available, and easily replaceable). In some examples, HDFS™ uses block storage or fixed-size blocks (e.g., 128 MB) spread across several different machines in order to parallelize read and write operations performed on data items. Distributing a file to multiple machines increases the risk of a file becoming unavailable if one of the machines in a cluster fails. HDFS™ can mitigate this risk by replicating each file block on multiple machines (e.g., by a replication factor of 3). Thus, if one or two machines serving a file block fail, that file can still be read. An HDFS™ cluster generally includes two types of nodes: a “name node” for managing the file system namespace (e.g., file metadata, such as file name, permissions, and file block locations) and one or more “data nodes” for storing the contents of the file in blocks. To provide fast access to the metadata, the name node can store all the metadata in memory.

The name node can periodically receive two types of messages from the data nodes in an HDFS™ cluster. One may be referred to as the “heartbeat,” and the other may be referred to as the “block report.” A data node can send a heartbeat message to inform the name node that it is functioning properly. A block report may contain a list of all the data blocks on a data node. When a client application wants to read a file, it can first contact a name node. The name node may respond with the locations of all the blocks that comprise that file. A block location can identify the data node that holds data for that file block. A client may then directly send a read request to the data nodes for each file block.

Similarly, when a client application wants to write data to an HDFS™ file, it may first contact the name node and ask it to create a new entry in the HDFS™ namespace. The name node checks whether a file with the same name already exists and whether the client has permission to create a new file. Next, the client application may ask the name node to choose data nodes for the first block of the file. It can create a pipeline between all the replica nodes hosting that block and send the data block to the first data node in the pipeline. The first data node may store the data block locally and forward it to the second data node, which can store it locally and forward it to the third data node. After the first file block has been stored on all the assigned data nodes, the client can ask the name node to select the data nodes to host replicas of the second block. This process may continue until all the file blocks have been stored on the data nodes. Finally, the client can inform the name node that the file writing is complete.

MapReduce provides a framework for processing large datasets in parallel across a computer cluster. MapReduce can abstract cluster computing and provide higher-level data entities for writing distributed data processing applications. The MapReduce framework can automatically schedule an application's execution across a set of machines in a cluster. MapReduce can handle load balancing, node failures, and complex internode communication.

A MapReduce application includes two functions: “map” and “reduce.” Both of these primitive functions are borrowed from functional programming. The map function can take a key-value pair as input and output a set of intermediate key-value pairs. The MapReduce framework may call the map function once for each key-value pair in the input dataset. Next, it may sort the output from the map functions and group all intermediate values associated with the same intermediate key. It can then pass them as input to the reduce function. The reduce function can aggregate those values and output the aggregated value along with the intermediate key that it received as its input.

Data storage layer 240 includes EDW 242 and data lake 244. As discussed, this is but one implementation of a data storage layer, and other examples includes a greater number of elements, fewer elements, or alternative elements. EDW 242 is a centralized repository comprising historical and current data from enterprise systems. An enterprise data warehouse is typically used by business intelligence systems to run various analytical queries, and EDW 242 can interface with an OLAP system to support multi-dimensional analytical queries.

In some examples, data storage layer 220 can also include optimized databases (sometimes referred to as analytical or operational databases) derived from EDW 242 to handle specific reporting and data analysis tasks. Some examples may also use data marts, subsets of the data stored in EDW 242 that belong to a department, division, or specific line of business of an enterprise. These data stores may be used when the data stored in EDW 242 reaches a size such that average query response times for data analysis tasks exceed a maximum latency threshold.

Data lake 244 can be a large data storage repository that can hold a vast amount of data (e.g., substantially all or all of the data flowing through a large enterprise) in its native format until it is needed. Data lake 244 can be polymorphous and include various types of databases or data stores, such as relational databases, key-value stores, document databases, graph databases, column-family databases, object store, file systems, etc. Data lake 244 can store data having various structures, including structured data, semi-structured data, and unstructured data. Data lake 244 can also store data in separate physical locations, such as on-premises (e.g., on enterprise-owned or leased property) or off-premises (e.g., within a public cloud) or in memory, disk, tape, or other suitable media. Although data storage layer 240 includes EDW 242 and data lake 244 as separate, complementary storage systems in this example, other examples may implement a data lake that incorporates an enterprise data warehouse.

Data analytics layer 260 includes ad-hoc querying tools 262, reporting tools 264, machine learning/analytics tools 266, and alerting tools 268. Ad-hoc querying tools 262 can provide various interfaces for clients (e.g., end-users, applications, etc.) to access data from data storage layer 240, such as through structured query language (SQL) querying engines (e.g., Apache Impala®, Apache Hive™, Presto, etc.), querying APIs of NoSQL databases (e.g., Apache Cassandra®, Apache HBase®, MongoDB®, etc.), text querying of search engines for document data stores (e.g., Apache Solr®, Elasticsearch®, etc.), EDM or MDM systems, and other suitable tools for accessing data from data storage layer 240.

Reporting tools 264 provide different ways for presenting the data from data storage layer 240, and include applications that organize and present data as tables; histograms; scatter plots; line, bar, pie, surface, area, flow, and bubble charts; data series or combinations of charts; timelines; Venn diagrams, data flow diagrams, entity-relationship (ER) diagrams; word/text/tag clouds, network diagrams, parallel coordinates (e.g., plots of individual data elements across many dimensions); treemaps (e.g., the display of hierarchical data in the form of nested or layered rectangles); cone trees (e.g., the display of hierarchical data in three dimensions in which branches grow in the form of cones); semantic networks (e.g., graphical representations of logical relationships between concepts); dashboards or other interactive visualization software (e.g., Data-Driven Documents (D3) (sometimes also referred to as D3.js), Qlikview®, Tableau®, etc.).

Machine learning/analytics tools 266 include processes for quantitative analysis, qualitative analysis, data mining, statistical analysis, machine learning, semantic analysis, or visual analysis, among other types of analyses. Quantitative analysis is a data analysis technique that focuses on quantifying the patterns and correlations found in the data. Based on statistical practices, this technique can involve analyzing a large number of observations from a dataset. Since the sample size is large, the results can be applied in a generalized manner to the entire dataset.

Qualitative analysis is a data analysis technique that focuses on describing various data qualities using words. It can involve analyzing a smaller sample in greater depth compared to quantitative data analysis. These analysis results cannot be generalized to an entire dataset due to the small sample size. They also may not be measured numerically or used for numerical comparisons. The output of qualitative analysis is often a description of the relationship(s) between datasets.

Data mining, also known as data discovery, is a specialized form of data analysis that targets large datasets. Data mining generally refers to automated, software-based techniques that sift through large datasets to identify patterns and trends. For example, data mining can involve extracting hidden or unknown patterns in the data for identifying previously unknown patterns. Data mining can form the basis for predictive analytics and business intelligence (BI).

Statistical analysis uses statistical methods based on mathematical formulas as a means for analyzing data. Statistical analysis is often quantitative, but can also be qualitative in certain situations. This type of analysis is commonly used to describe datasets via summarization, such as providing the mean, median, or mode of statistics associated with the dataset. Statistical analysis can also be used to infer patterns and relationships within the dataset, such as a/b testing (e.g., comparing two versions of an element to determine which is superior based on a predefined metric), regression (e.g., determining how a dependent variable is related to an independent variable within a dataset), and correlation (e.g., determining whether two variables are related to each other), among others.

Machine learning takes advantage of the ability of computers to process large amounts of data very quickly to find patterns and relationships with data. Some examples of use cases for machine learning include classification, clustering, anomaly detection, filtering, and semantic analysis. Classification generally includes two phases, a training phase in which a computer receives training data that is already categorized or labeled so that the computer can develop an understanding of the different categories, and a testing phase, in which the computer applies the knowledge learned during the training phase to classify or label new data.

Clustering is a machine learning technique in which data is divided into different groups so that the data in each group has similar properties. There is no prior learning of categories required. Instead, categories are implicitly generated based on the data groupings. How the data is grouped can depend on the type of algorithm used as each clustering algorithm uses a different technique to identify clusters.

Anomaly detection is the process of finding data that is significantly different from or inconsistent with the rest of the data within a given dataset. This machine learning technique is used to identify outliers, abnormalities, and deviations within a dataset. Some applications of anomaly detection include malicious network activity, fraud detection, medical diagnosis, sensor data analysis, and the like.

Filtering is the automated process of finding relevant items from a pool of items. Items can be filtered either based on a user's own behavior or by matching the behavior of multiple users. Filtering can be collaborative, in which the attributes of a target entity are used to identity other entities having similar attributes and predicting the target entity will behave in a manner similar to those other entities, or content-based, in which the relationship between a first entity and a second entity is identified and used to predict that the first entity will have a similar relationship to a third entity because of the similarities between the second and third entities.

Semantic analysis involves extracting meaningful information from text and speech data. Some applications of semantic analysis include natural language processing, text analytics, or sentiment analysis. Natural language processing algorithms attempt to program a machine to understand speech or text in a similar manner as persons understand the speech or text. Text analytics is the specialized analysis of text through the application of data mining, machine learning, and natural language processing techniques to extract value out of unstructured text. Text analytics includes a parsing phase, in which text is parsed to identify named entities (e.g., proper nouns), pattern-based entities (e.g., telephone number, address, driver's license number, etc.), concepts (e.g., an abstract representation of an entity or group of entities), or relationships between entities, and a categorization phase, in which the text is categorized using the extracted entities, concepts, and relationships between entities. Sentiment analysis is a specialized form of text analysis that focuses on determining the bias or emotions of individuals. This form of analysis determines the attitude of the author of the text by analyzing the text within the context of the natural language.

Visual analysis is a form of data analysis related to the graphic representation of data to enable or enhance its visual perception. The graphic representations of data items can be used to develop a deeper understanding of the data items, such as by identifying and highlighting hidden patterns, correlations, and anomalies. Some examples of visual analysis techniques include heat maps, time series plots, histograms, graphs, and spatial data mapping, among other possibilities.

Alerting tools 268 enable administrators to receive advance notice of events occurring in data architecture 200. In some examples, alerting tools 268 include an interface for the administrators to define rules or trigger conditions that automatically send notifications upon occurrence of the conditions. Some example use cases for alerting tools 268 include login analysis, brute force attack detection, denial of service (DOS) or distributed denial of service (DDOS) attack detection, and the like.

In this example, data architecture 200 includes certain tiers for providing common functionality across data source layer 202, data collection layer 220, data storage layer 240, and data analytics layer 260. An underlying goal of modern data architectures is to capture substantially all or all of the data passing through the network to analyze the data and to discover insights about a business or organization associated with the network that are not readily apparent to users or not specifically monitored by users. However, the value of data tends to decrease, and the risks associated with massive scale storage increase over time. Users can promulgate the rules governing the types of data that data architecture 200 can store. Users can also define the policies for classifying which data is valuable, how long to store the data, and where to store the data at different periods of time. Data governance tier 270 includes tools that downgrade, archive, or delete data based on the classified policy.

Metadata management tier 280 includes functionality for capturing information associated with data items of data architecture 200 (e.g., data other than the content of the data items) across data source layer 202, data collection layer 220, data storage layer 240, and data analytics layer 260. This metadata includes identification information, entity and attribute information, quality information, data lineage, distribution information, and other associated information. In some examples, metadata management tier 280 includes indexers for generating indices to enable efficient search of the data items and annotators or decorators for tagging or enhancing the data items with supplemental associated information.

In some examples, metadata management tier 280 can support data versioning. For example, administrators can define the structure of raw data of data source layer 202 and describe the entities inside data items of the raw data within metadata management tier 280 (e.g., base-level descriptions). The schemas, ontologies, data models, and the like of data architecture 200 can change over time from interactions between and among data source layer 202, data collection layer 220, data storage layer 240, and data analytics layer 260. Metadata management tier 280 includes versioning tools to monitor the evolution of the schemas, ontologies, and data models.

In some examples, components of data analytics layer 260 can interface with metadata management tier 280 to retrieve information that the components need to perform their analytical tasks. Some of the functionality of data analytics layer 260 that metadata management tier 280 can support include self-service business intelligence, (SSBI) data as a service (DaaS), machine learning as a service (MLaaS), data provisioning (DP), analytics sandbox provisioning (ASP), among other services.

Security management tier 290 generally includes functionality for controlling the rights to access, define, and modify data. Security management tier 290 includes tools for managing the creation, usage, and tracking of data across the layers of data architecture 200 and coordinating these rights with security rules. These rules can determine appropriate access control and authentication for data, such as on a need-to-know basis or available to the general public for dissemination. Security management tier 290 can safeguard the appropriate provisioning of data and put suitable security measures in place. For example, if a data set includes a business or organization's transaction and historical data, such as internally sourced customer, product, and/or financial data, as well as data from third-party sources, security management tier 290 can ensure that each of the scopes of the data has the applicable level of security.

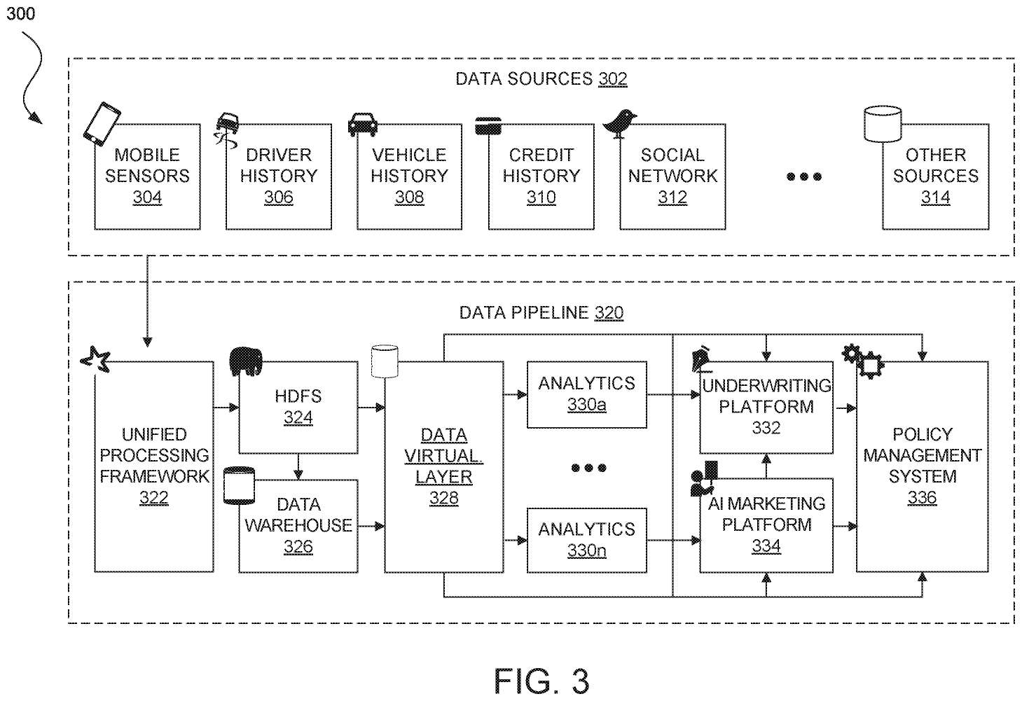

FIG. 3 shows another example of a big data system, data architecture 300, that some examples of the present disclosure may implement for supporting analysis of voluminous, high-velocity, and highly varied data. Other examples may implement a data architecture similar to data architectures 200 or 300 but interchange respective elements of these architectures, add elements to these architectures from other data architectures, exclude elements from these data architectures, or exchange elements of these data architectures with elements from other data architectures, and continue to practice the subject matter of the present disclosure. In addition, for illustrative purposes, data architecture 300 includes functionality for providing online personal auto insurance, but the system is equally applicable to various technological fields, such as systems for data center management, infrastructure-as-a-service (IaaS), platform-as-a-service (PaaS), software-as-a-service (SaaS), and other network-based applications and services.

In this example, data architecture 300 comprises data sources 302 and data pipeline 320. Data sources 302 includes mobile sensor data 304, driver history data 306, vehicle history data 308, credit history data 310, social network data 312, and other data 314. Mobile sensor data 304 includes data from sensors, and I/O components of portable electronic devices (e.g., smartphones, tablets, wearable devices, etc.) that can be carried by users or that can be affixed to users' bodies, telematic devices that users can carry or attach to a vehicle or that are incorporated in the vehicle, and the like. These sensors and I/O components can generally provide information relating to the users' driving habits. Some examples of these sensors and I/O components include global positioning systems (GPS), accelerometers, gyroscopes, magnetometers, inclinometers, proximity sensors, distance sensors, depth sensors, range finders, ultrasonic transceivers, or other motion/position/orientation sensors and devices; cameras, ambient light sensors, infrared (IR) transceivers, ultraviolet (UV) transceivers, or other optical, light, imaging, or photon sensors. The data captured by these sensors and I/O components may be used to derive the user's geographic position, driving speed, average daily usage, average number of trips in a day, average travel lengths, braking force, whether the user drives local streets or a freeway, whether the user comes to a complete stop, differences between driving during the day or at night, differences between driving in normal weather and inclement weather, and other driving habits.

Driver history data 304 includes data regarding traffic events that a user may have been involved with historically, such as traffic accidents or losses and traffic offenses or moving violations. This data can come from police records, court records, driver history reports prepared by insurer, and similar sources. Vehicle history data 306 includes information regarding specific vehicles associated with a user, including previously owned or used or currently owned or used vehicles. Some examples of vehicle history data 306 include traffic accidents that a vehicle has been involved in and other types of damage to the vehicle, the extent of damage to the vehicle for each accident or other incident, title and ownership information, mileage, service history, sales information (e.g., manufacturer's recommended selling price (MSRP), Bluebook® value, etc.), registration and inspection information, recalls, and other similar types of information. Credit history data 308 includes information regarding a user's credit score and related information regarding the user's credit-worthiness based on the outstanding amount of loans the user has taken, the amount of credit available to the user, payment history, defaults, and other similar types of data.

Social network data 310 includes information relating to users' social network interactions, and includes shared photos, videos, events, web log (blog) entries, social network posts, hyperlinks, and other shared content; demographic information (e.g., gender, age, race/ethnicity, geographic region history, education history, work history, relationship history, relationships, etc.); status information (e.g., current geolocation, activity, mood, etc.); personal preferences (e.g., favorite films, books, music, etc.); contacts, group memberships, and other user affinity or affiliation information; “likes,” “dislikes,” ratings, comments, and other sentiment information; and other online social activities.

Other data sources 314 includes user information provided via a provider's website, desktop application, mobile application (app), chatbot interface, customer support interface, and other interactions between a user and the provider. In some examples, the provider can offer a mobile app that enables a user to scan her driver's license to quickly capture information such as her date of birth, address, issue data, driver's license issue date, driver's license expiration date, and other related information.

Table 1 sets forth a summary of the data sources and types of data that can be extracted from the data sources in some examples for providing online personal auto insurance.

TABLE 1
Example data sources and types of data collected for auto insurance quote

| Data Source | Types of Data |
|---|---|
| User | Driver's license scan (date of birth, gender, address, driver's license issue |
| On-Boarding | date, driver's license expiration date) |
| Policy History | Associated vehicles (vehicle identification number, year, make, model, |
| and Coverage | trim); policy history information (policy carrier, inception date, policy type, |
| Lapse | effective date, expiration date, premium amount, coverage limits) |
| Information | |
| Vehicle Risk | Geographic relativity symbols, vehicle rating symbols (bodily injury, |
| Profiler | property damage, personal injury protection, medical payments, collision, |
| | comprehensive) |
| Credit Report | Open high credit ration, trade counts, average trade age, oldest trade age, |
| | reported auto trades, delinquencies, satisfactory trade count, collection |
| | count, auto group inquiries, non-auto inquiries |
| Loss History | 7 years of loss history information on all loss and coverage types; loss |
| | types (bodily injury liability, property damage liability, personal injury |
| | protection, collision, comprehensive) |
| Vehicle history | Title information, vehicle specifications, National Highway Traffic Safety |
| and title report | Administration (NHTSA) recall records, junk/salvage/loss status, title |
| | brand information, odometer brand information |
| Driver Risk | Minor violation factor (e.g., speeding); major violation factor (e.g., driving |
| | under the influence (DUI)) |
| Mobile sensor | GPS/location data; instant and time-series motion/position/orientation data, |
| data | driving speed, average daily usage, average number of trips in a day, |
| | average travel lengths, braking force, whether the user drives local streets |
| | or a freeway, whether the user comes to a complete stop, differences |
| | between driving during the day or at night, differences between driving in |
| | normal weather and inclement weather, and other driving habits |

The various components of data architecture can communicate with one another in various ways, such as application programming interfaces (APIs), inter-process communications (IPC), remote procedure calls (RPCs), messaging (e.g., Java Message Service (JMS), Message Queueing Telemetry Transport (MQTT), Advanced Messaging Queueing Protocol (AMQP), etc.), distributed object services (e.g., Component Object Model (COM), Common Object Request Broker Architecture (CORBA), Java Beans, etc.), among other techniques known to a skilled artisan. In some examples, components of a network may communicate using a restful state transfer (REST) design pattern in which a server enables a client to access and interact with Internet resources via uniform resource identifiers (URIs) using a set of predefined stateless operations (referred to as endpoints). The server and client may exchange requests and responses in JavaScript Object Notation (JSON) or eXtensible Mark-up Language (XML) format.

In this example, data sources 302 may communicate with data pipeline 320 via unified processing framework 322. In some examples, unified processing framework 322 may be based on Apache Spark™ 2.x+. Spark™ is an in-memory cluster computing framework for processing and analyzing large datasets and a wide range of workloads (e.g., batch, iterative, interactive, streaming, etc.). The Spark™ framework comprises Spark™ Core, Spark™ SQL, Spark™ Streaming, MLib, and GraphX.

Spark™ Core provides the basic functionality of the Spark™ processing framework, and includes components for task scheduling, memory management, fault recovery, and interacting with storage systems, among others. Spark™ Core also includes the API for the Spark™ framework's basic building blocks, resilient distributed datasets (RDDs). RDDs represent a collection of items distributed across many compute nodes that can be operated upon in parallel. Spark™ Core provides the functions for operating on these collections.

Spark™ SQL is a component of the Spark™ framework that allows for querying of data persisted in a variety of types of data stores (e.g., key-value stores, graph databases, column-family databases, etc.) using SQL or variants (e.g., Apache Hive™ Query Language (HQL)). Spark™ SQL also supports integration of SQL and SQL-like queries with operations on RDDs using programmatic languages (e.g., Python™, Oracle Java®, Scala, etc.).

Spark™ Streaming is a component of the Spark™ framework for processing data streams. Spark™ Streaming provides an API for operating on data streams that closely matches Spark™ Core's API for operating on RDDs, making it easy for programmers to learn the project and move between applications that manipulate data stored in memory, on disk, or arriving in real time.

MLlib is a machine learning library, and provides functionality for classification, regression, clustering, and collaborative filtering, as well as supporting functionality such as model evaluation and data import. MLlib also exposes some lower-level ML primitives, such as generic gradient descent optimization.

GraphX is a library for operating on graphs and performing graph computations in parallel. GraphX also provides functions for operating on portions of a graph (e.g., vertices, edges, subgraphs) and common graph algorithms (e.g., PageRank, triangle counting, etc.).

A Spark™ application generally includes a driver program, a cluster manager, workers, executors, and tasks. The driver program operates as a library to provide the data processing code executed by the workers. The cluster manager acquires resources for executing the application. The cluster manager (e.g., standalone, Apache Mesos®, YARN, etc.) coordinates computing resources across a cluster, provides low-level scheduling of cluster resources across applications, and enables multiple applications to share cluster resources and run on the same workers. The workers provide CPU, memory, and storage resources to the application and run the application as distributed processes on a cluster. The executors are virtual machines (e.g., Java® virtual machine (JVM)) created on each worker. The executors can execute code concurrently in multiple threads and can also cache data in memory or disk. A task is the smallest unit of work the application sends to an executor, which is executed by a thread in the executor. Each task performs some computations to either return a result to the driver program or partition its output for shuffle. The Spark™ application creates a task per data partition. As executors can run one or more tasks concurrently, the amount of parallelism is determined by the number of partitions. More partitions mean more tasks processing data in parallel.

Unified processing framework 322 collects data from various data sources (e.g., data sources 302), process the data, and store the data to HDFS™ 325. HDFS™ 324 can effectively operate as an operational data store, and copy data that needs to be persisted to data warehouse 326, and data warehouse 326 can effectively operate as a master data store. Data virtualization layer 328 operates abstract away the complexities of the interrelationship between HDFS™ 324 and date warehouse, and provide access to all data sources and to support different modes of access to support analytical services (e.g., a quantitative analytics tool and a predictive analytics tool) and downstream services (e.g., underwriting platform 332, marketing platform 334, and policy management system 336).

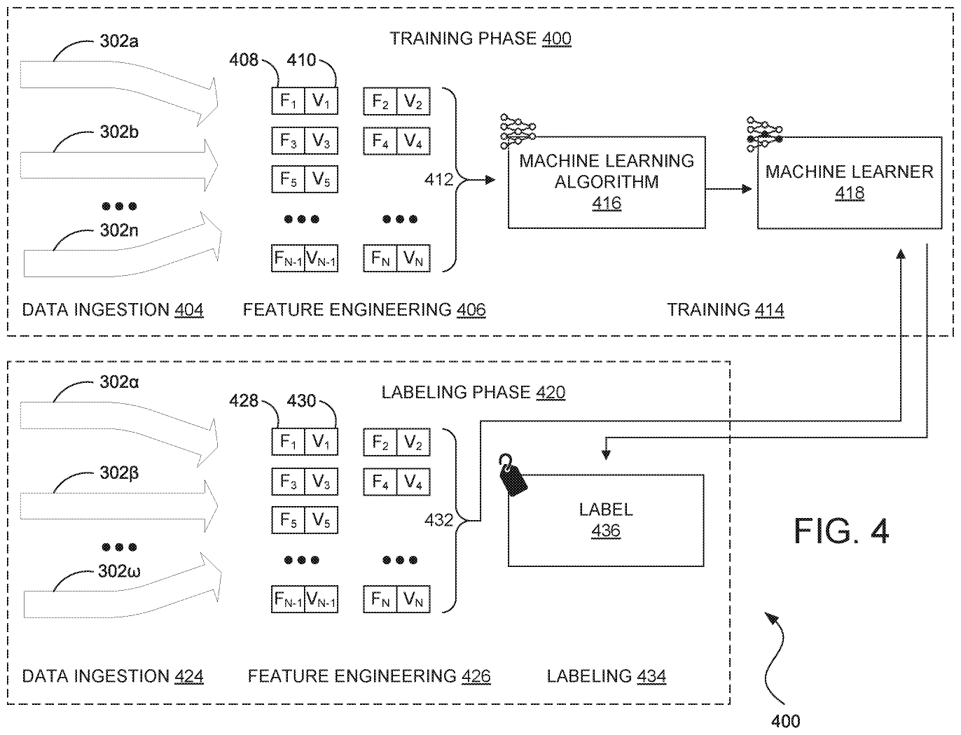

Users (e.g., data scientists or automated systems) accesses data stored in data virtualization layer 328 using analytical tools 330a . . . 330n (collectively, 330) (e.g., quantitative analytical tools, qualitative analytical tools, data mining tools, statistical analytical tools, machine learning tools, semantic analytical tools, or visual analytical tools, among other types of tools). The present disclosure discusses analytical tools 330 further below with respect to FIG. 4. Output from analytical tools 330 can feed into downstream systems, such as underwriting platform 332, artificial intelligence (AI) marketing platform 334, and online personal auto insurance policy management system 336.

Underwriting platform 332 can provide underwriting, risk management, risk mitigation, and policy issuance via real-time monitoring of a risk portfolio's performance; advanced data processing, storage, and analytics tools within a distributed infrastructure; and machine learning modules having built-in business intelligence to generate actionable insights for data scientists and that proactively measure various underwriting factors/variables.

AI marketing platform 334 can be a marketing intelligence platform that ingests live marketing, customer interaction, and contextual data to determine marketing campaign allocations. AI marketing platform 334 can ingest conversion, social activity, cost, user interaction, census data, and thematic travel map data to optimize market strategy and allocations. In some examples, AI marketing platform 334 can integrate with underwriting platform 332 to provide a holistic view of marketing campaign profitability. AI marketing platform 334 can monitor the performance of multiple marketing efforts, evaluate campaign efficacy, and communicate to underwriting platform 332 to understand where AI marketing platform 334 has produced best risk. AI marketing platform 334 can learn marketing reallocation strategy in real-time. In some examples, AI marketing platform 334 includes built-in tempering parameters to protect the bottom-line against growth. AI marketing platform 334 can bolster successful campaigns in existing markets and learn scalable strategies in new markets.

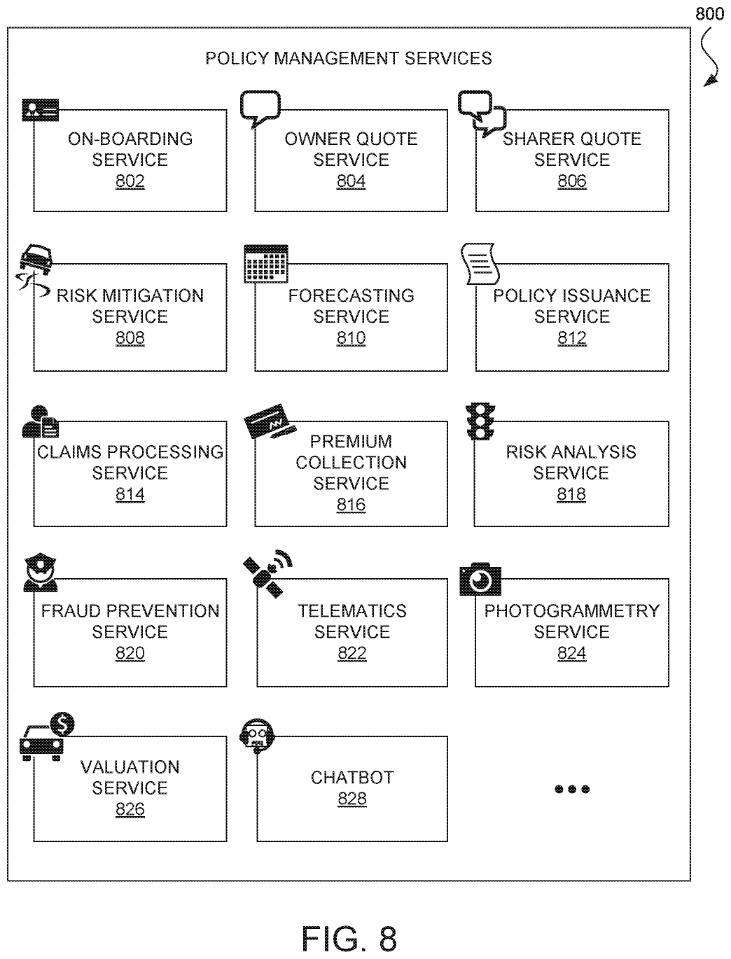

AI marketing platform 334 can implement various strategies relating to personal auto insurance for vehicle sharing/borrowing, such as locale-rank, ambulance chaser event trigger, and weather incident event trigger, among others. Regarding the locale-rank strategy, AI marketing platform 334 can learn which data feeds correlate to locales with many car-sharing residents using neighborhood block-level geography, demographic homogeneity, and number of vehicles in the household. In an embodiment, regions have been scored based on value proposition resonance and population sharing likelihood. Regions can be filtered, and focused campaigns can begin in the top scoring regions. The ambulance chaser event trigger strategy can involve real-time, hyper-localized digital advertising campaigns to advertise to rubbernecking consumers based on live accident data streams. These consumers may be especially interested in liability and insurance marketing. A weather incidents event trigger strategy can allow AI marketing platform to run localized awareness campaigns when there are climactic weather patterns. A personal auto insurance provider can be advertised to mirror weather patterns and give conversational material for an audience anxious about protecting their assets. Additional details regarding underwriting platform 332 and AI marketing platform 334 are discussed further below with respect to FIG. 8 and elsewhere in the present disclosure.

FIG. 4 shows data flow 400 of a machine learning system that may be used to implement analytical tools 330, underwriting platform 332, AI marketing platform 334, or policy management system 336. For any method, process, or flow discussed herein, there can be additional, fewer, or alternative steps performed or stages that occur in similar or alternative orders, or in parallel, within the scope of various examples unless otherwise stated. For illustrative purposes, data flow 400 can be used to evaluate prospective users to determine their suitability for one or more personal auto insurance policies. However, one of ordinary skill in the art will understand that data flow 400 can be used in a variety of other contexts discussed throughout the present disclosure.

Data flow 400 includes training phase 402 and labeling phase 420. In this example, training phase 402 includes data ingestion stage 404, feature engineering stage 410, and training stage 414. Data ingestion stage 404 can involve collecting raw data from data sources 302a, 302b, . . . . 302n (collectively, 302), such as mobile sensor data 304, driver history data 306, vehicle history data 308, credit history data 310, social network data 312, and other data 314 of FIG. 3. As discussed, there can be multiple ways for ingesting data, including an ETL framework, a stream processing framework, a distributive processing framework, application-specific data adapters, or a combination of these approaches.

Feature engineering stage 406 involves transforming, translating, or otherwise processing data from an original form to another form more suitable for machine learning modeling. Feature engineering stage 406 includes tasks such as identifying features 408 and corresponding feature values 410 from data sources 302 and generating feature vector 412, a representation of the identified features and associated feature values.

A feature is generally a quality of an object that can define the object in part, and may be used to compare the similarities or differences of the object with other objects. Features can reside in various data domains, and there can be Boolean features (e.g., married or not married, children or no children, urban dweller or not an urban dweller, etc.), numeric features (e.g., age, years or driving experience, number of miles driven annually, etc.), date features (e.g., birthdate, date of last traffic incident, date of last traffic violation, etc.), text features, image features (e.g., features of photos and videos, such as photos of a vehicle, odometer reading photo, video from a traffic incident, etc.), and application-specific features (e.g., encodings of associated vehicles, credit history, traffic incidents, etc.). Extraction of Boolean features, numeric features, and date features generally require very little to no pre- or post-processing because they are already in a format to easily compare one data entity (e.g., a car owner, a car borrower, a policy, etc.) from another. Text features, image features, and application-specific features can require additional pre- and post-processing.

Text features includes lexical features, semantic features, and syntactic features. Lexical features generally identify the relationships between words and phrases of text. An example of a lexical feature is the term frequency-inverse document frequency (tf-idf) of a word or phrase. The tf-idf score measures the relevance of the word or phrase in a collection or corpus based on how often the word or phrase appears in a segment of text and how often the word or phrase appears over the entirety of the collection or corpus of text. Other examples of lexical features include the part of speech of a word or phrase, the probability that certain words and phrases repeat in the same segment (e.g., there may be a low probability that “don't” appears twice in the same sentence), or the pairwise or sequential probability of words and phrases (e.g., the probability a pair of words or a sequence of words occurring one after another in a sentence, paragraph, or other unit of text).

Semantic features can measure the similarities and differences in the meanings of words and phrases of the text. Some examples of semantic features include those based on semantic networks and corpus-based measures. Semantic networks are graphs used to represent the similarity or relatedness of words and phrases of text. An example of a semantic network is WordNet, an English-language database that groups words into sets of synonyms (referred to as “synsets”) and annotates relationships between synsets, such as hypernyms, hyponyms, troponyms, and entailments (e.g., variations of is-a-kind-of relationships between words and phrases), coordinate terms (e.g., words that share a hypernym), meronyms and holonyms (e.g., words and phrases having is-a-part-of relationship), etc. Various semantic features use different ways of measuring similarity between a pair of words based on how to traverse a semantic network and how to quantify nodes (e.g., words) and edges (e.g., relationships) during traversal. Examples of ways to traverse a semantic graph include the Least Common Subsumer, Path Distance Similarity, Lexical Chains, Overlapping Glosses, and Vector Pairs. The Least Common Subsumer uses is-a-kind-of relationships to measure the similarity between a pair of words by locating the most specific concept, which is an ancestor of both words. One example for quantifying the semantic similarity calculates the “information content” of a concept as negative log d, where d is the depth of the tree including the pair of words having the least common subsumer as its root, and where the similarity is a value between 0 and 1 (e.g., Resnik semantic similarity). Variations of the Least Common Subsumer normalize the information content for the least common subsumer, such as by calculating the sum of the information content of the pair of words and scaling the information content for the least common subsumer by this sum (e.g., Lin semantic similarity) or taking the difference of this sum and the information content of the least common subsumer (e.g., Jiang & Conrath semantic similarity).

Path Distance Similarity measures the semantic similarity of a pair of words based on the shortest path that connects them in the is-a-kind-of (e.g., hypernym/hyponym) taxonomy. Variations of Path Distance Similarity normalize the shortest path value using the depths of the pair of words in the taxonomy (e.g., Wu & Palmer semantic similarity) or the maximum depth of the taxonomy (e.g., Leacock and Chodorow).

Lexical Chains measure semantic relatedness by identifying lexical chains associating two concepts, and classifying relatedness of a pair of words, such as “extra-strong,” “strong,” and “medium-strong.” Overlapping glosses measure semantic relatedness using the “glosses” (e.g., brief definition or concept of a synset) of two synsets, and quantifies relatedness as the sum of the squares of the overlap lengths. Vector pairs measure semantic relatedness using co-occurrence matrices for words in the glosses from a particular corpus and represent each gloss as a vector of the average of the co-occurrence matrices.

Corpus-based semantic features quantify semantic similarity between a pair of words from large bodies of text, such as Internet indices, encyclopedias, newspaper archives, etc. Examples of methods for extracting corpus-based semantic features from text include Hyperspace Analogue to Language (HAL), Latent Semantic Analysis (LSA), Latent Dirichletian Allocation (LDA), Explicit Semantic Analysis (ESA), Pointwise Mutual Information-Information Retrieval (PMI-IR), Normalized Google® Distance (NGD), and Distributionally similar words using Co-occurrences (DISCO), among others. HAL computes matrices in which each matrix element represents the strength of association between a word represented by a row and a word represented by a column. As text is analyzed, a focus word is placed at the beginning of a ten-word window that records which neighboring words are counted as co-occurring. Matrix values are accumulated by weighting the co-occurrence inversely proportional to the distance from the focus word, with closer neighboring words weighted higher. HAL also records word-ordering information by treating co-occurrences differently based on whether the neighboring word appears before or after the focus word.

LSA computes matrices in which each matrix element represents a word count per paragraph of a text with each row representing a unique word and each column representing a paragraph of the text. LSA uses singular value decomposition (SVD) to reduce the number of columns while preserving the similarity structure among rows. Words are then compared by taking the cosine angle between the two vectors formed by any two rows.

A variation of LSA is LDA in that both treat each document as a mixture of various topics of a corpus. However, while LSA uses a uniform Dirichletian prior distribution model (e.g., a type of probability distribution in which the probability of each bin of the distribution is between 0 and 1, and the sum of the probabilities is equal to 1), LDA uses a sparse Dirichletian prior distribution model. LDA involves randomly assigning each word in each text to one of k topics to produce topic representations for all documents and word distributions for all topics. After these preliminary topic representations and word distribution are determined, LDA computes, for each text and each word in the text, the percentage of words in the text that were generated from a particular topic and the percentage of that topic that came from a particular word across all texts. LDA will reassign a word to a new topic when the product of the percentage of the new topic in the text and the percentage of the word in the new topic exceeds the product of the percentage of the previous topic in the text and the percentage of the word in the previous topic. After many iterations, LDA may converge to a steady state (e.g., the topics converge into k distinct topics). Because LDA is unsupervised, it may converge to very different topics with only slight variations in training data. Some variants of LDA, such as seeded LDA or semi-supervised LDA, can be seeded with terms specific to known topics to ensure that these topics are consistently identified.

ESA represents words as high-dimensional text feature vectors with each vector element of a vector representing the tf-idf weight of a word relative to a body of text. The semantic relatedness between words may be quantified as the cosine similarity measure between the corresponding text feature vectors.

PMI-IR computes the similarity of a pair of words using search engine querying to identify how often two words co-occur near each other on a web page as a semantic feature. A variation of PMI-IR measures semantic similarity based on the number of hits returned by a search engine for a pair of words individually and the number of hits for the combination of the pair (e.g., Normalized Google Distance). DISCO computes distributional similarity between words using a context window of size ±3 words for counting co-occurrences. DISCO can receive a pair of words, retrieve the word vectors for each word from an index of a corpus, and compute cosine similarity between the word vectors. Example implementations of semantic similarity measures can be found in the WordNet::Similarity and Natural Language Toolkit (NLTK) packages.

Text features can also be character-based features or term-based features. Character-based features determine the similarity of a pair of strings or the extent to which they share similar character sequences. Examples of character-based features include Longest Common Substring (LCS), Damerau-Levenshtein, Jaro, Needleman-Wunsch, Smith-Waterman, and N-gram, among others. LCS measures the similarity between two strings as the length of the longest contiguous chain of characters in both strings. Damerau-Levenshtein measures the distance between two strings by counting the minimum number of operations to transform one string into the other. Jaro measures similarity between two strings using the number and order of common characters between the two strings. Needleman-Wunsch measures similarity by performing a global alignment to identify the best alignment over the entire of two sequences. Smith-Waterman measures similarity by performing a local alignment to identify the best alignment over the conserved domain of two sequences. N-grams measure similarity using the n-grams (e.g., a subsequence of n items of a sequence of text) from each character or word in the two strings. Distance is computed by dividing the number of similar n-grams by the maximal number of n-grams.

Term-based features can also measure similarity between strings but analyze similarity at the word level (instead of the substring level) using various numeric measures of similarity, distance, density, and the like. Examples of term-based similarity measures include the Euclidean distance, Manhattan distance, cosine similarity, Jaccard similarity, and matching coefficients. The Euclidean distance (sometimes also referred to as the L2 distance) is the square root of the sum of squared differences between corresponding elements of a pair of feature vectors. The Manhattan distance (sometimes referred to as the block distance, boxcar distance, absolute value distance, L1 distance, or city block distance) is the sum of the differences of the distances it would take to travel to get from one feature value of a first text feature vector to a corresponding feature value of a second text feature vector if a grid-like path is followed. Cosine similarity involves calculating the inner product space of two text feature vectors and measuring similarity based on the cosine of the angle between them. Jaccard similarity is the number of shared words and phrases over the number of all unique terms in both text feature vectors.

While lexical and semantic features attempt to capture the substance or meaning of text, syntactic features attempt to capture the form of text. Some examples of syntactic features include parts of speech (POS), punctuation, capitalization, formatting, and the like.

An online personal auto insurance system can use image data (e.g., photos and videos) in a variety of ways, such as to evaluate a physical state of a vehicle before a borrower takes possession or after a traffic accident, authenticate an identity of a car borrower for keyless entry and start-up of a vehicle, verify that a driver of a vehicle is an insuree, identify a location via background image data, or analyze user behavior while driving from video data, among other use cases. Thus, in some examples, feature engineering stage 406 includes processing of image data and extraction of features from the image data. Image features include points, edges, or regions of interest. Point of interest or key points include the intersections of edges, high variance points, local curvature discontinuities of Gabor wavelets, inflection points of curves, local extrema of wavelet transforms, Harris corners, Shi Tomasi points, or scale-invariant feature transform (SIFT) key points, among others. Edges can mark the boundaries between regions of different colors, intensities, or textures. Some examples of edge-based features include Canny edges, Shen-Castan (ISEF) edges, Marr-Hildreth edges, Lindeberg edges, phase stretch transform (PST) edges, and random sample consensus (RANSAC) lines, among others. Image feature extractor 112 may also identify regions of interest in image data. These regions of interest may be detected based on Laplacian of Gaussian (LoG) regions, difference of Gaussian regions (DoG), determinant of Hessian (DoH) regions, and maximally stable extremum regions (MSERs), determinant of Hessian blobs, and maximally stable extremum regions (MSERs), among many others.

Image features can also include color, texture, shapes, or frequency-domain features. Feature vector 412 can encode the color of image data using histograms (e.g., distributions of the number of pixels of each color of the image data), color coherent vectors (CCVs) (e.g., a special type of histogram that accounts for spatial information by partitioning histogram bins as coherent where a color is a part of a common region and incoherent otherwise), color moments and moment invariants (e.g., an index of a set of colors of the image data and where each color is located in the image data), or color SIFT key points. Image feature engineering processes can also identify textures within image data, such as by computing a gray level co-occurrence matrix (GCLM) (e.g., motion estimation from measures of the angular second moment, correlation, inverse difference moment, and entropy), Haralick texture matrix (e.g., information regarding texture patterns in the image data), or visual texture descriptors (e.g., measures of regularity, directionality, and coarseness of discrete regions of the image data). Image features can also be determined transforming an image represented by f(x,y) of size M×N to a representation F(u,v) in the frequency domain, and extracting features from F(u,v). Some examples of frequency-domain features include binary robust independent elementary features (BRIEF), oriented fast and rotated BRIEF (ORB), binary robust invariant scalable key points (BRISK), and fast retina key points (FREAKs).

Application-specific features vary from case to case depending on the application. For example, an example of a data source is driver history data 306 of FIG. 3. In one implementation, the system may only be interested the number of traffic accidents that a user has been involved in the past 3 years. One or more application-specific adapters for this piece of data may parse the traffic history report for traffic incidents involving the user over the past 3 years, sum the number of traffic incidents, and output the sum. In another implementation, the system may be interested in the intervals between traffic incidents over the years the user has driven. One or more application-specific adapters for this data may parse the traffic history report for traffic incidents over the years the user has driven, extract the date of each incident, calculate the intervals between each incident, and output an array comprising a date (e.g., first traffic incident or last traffic incident) and the number of days following the date (e.g., if starting from first traffic incident) or the number of days preceding the date (e.g., if starting from latest traffic incident) of each traffic incident.

Feature vectorization can follow feature extraction. A feature vector is a data structure for holding features of a data entity or a composite of the features of the data entity. Whether extraction is de minimis or exhaustive, the feature vector can represent the essential details of the data entity to help distinguish the data entity or mark its similarity with other data entities. Feature vectorization includes a process sometimes referred to as fusion that involves combining the features of the data entity into a data object (e.g., feature vector) that can operate as a sample or data point for training stage 414. Fusion can occur early or late.

In early fusion, feature values may be concatenated to form a vector, array, list, matrix, or other suitable data structure. In some examples, the vector may be dense and each position of the vector can comprise a feature as a key and a feature value as a value of a key-value pair. In other examples, the vector may be sparse, and each position of the vector can represent a different feature, and the vector includes a feature when there is a non-null value (or 0 or −1 depending on the data type of the feature) at the corresponding position of the vector. As discussed, features may lie in various domains (e.g., Boolean, numeric, date, semantical, lexical, syntactic, image features, etc.), and a feature vector in an early fusion system can combine disparate feature types or domains. Early fusion may be effective for a feature set of similar features or features within the same domain (e.g., dates of traffic accidents and dates of traffic violations). Early fusion may be less effective for distant features or features from different domains (e.g., credit history score versus image features of photos or videos of a vehicle).

In late fusion, features in the same domain may be combined and each feature vector can be input into a separate, domain-specific machine learning system and later joined. The domain-specific machine learning systems may use the same or different machine learning algorithms. A collection of feature vectors from each domain-specific machine learning system can represent a data entity or sample point.

In other examples, the results of each individual domain-specific machine learning system for an item listing may be compared with one another, such as by generating a similarity vector in which each position of the vector is the similarity between a pair of data entities along one domain, and a final representation may be based on averaging, weighted averaging, or percentiling/binning. In averaging, the similarity S of two data entities j and k can be the sum of the value of each position of the similarity vector v divided by the length n of the similarity vector. For example:

S_{j:k}=(Σᵢ₌₀ⁿ⁻¹v(i))/n (Equation 1)

Weighted averaging may apply different weights w to the positions of the similarity vector v to determine the similarity between the item listings j and k. For example:

S_{j:k}=(Σᵢ₌₀ⁿ⁻¹wᵢv(i))/n, where Σᵢ₌₀ⁿ⁻¹wᵢ=1 (Equation 2)

Weights can be user-specified or automatically obtained, such as via silhouette scores. A silhouette score is a measure of how similar an object is to its own cluster or class compared to other clusters or other classes, which can range from −1 to 1, where a high value indicates that a data entity is well matched to its own cluster or class and badly matched to neighboring clusters or classes. If most data entities have a high silhouette score, then the clustering or classification maybe accurate. If many item listing have a low or negative silhouette score, then the clustering or classification may have too many or too few clusters or classes. The silhouette score can be calculated with any similarity or distance metric, such as the Euclidean distance or the Manhattan distance. Percentiling or binning maps the value of each position of a similarity vector to percentiles or bins to account for different similarity distributions. That is, similarity vectors are sorted and bins of the sorted vectors are created according to a particular probability distribution (e.g., normal or Gaussian, Poisson, Weibull, etc.). For example, the probability P, for a probability density function f, that a data entity X belongs to a cluster or class associated with a percentile/bin over interval a and b may be defined as:

P=[a≤X≤b]=∫ₐ^{b}f(x)dx (Equation 3)

In still other examples, late fusion can involve various set operations. For example, late fusion may define clusters or classes as the intersections, unions, or complements of feature vectors. That is, if a first feature vector, as determined by a first machine learning system, includes the values {1, 2, 3, 4} and a second feature vector, as determined by a second machine learning system, includes the values {3, 4, 5}, then the intersection operation may result in clusters or classes {1}, {2}, {3, 4}, and {5}. On the other hand, applying the union operation to the first and second feature vectors may yield a single cluster or class {1, 2, 3, 4, 5}.

In some examples, feature vectorization can also include handling of missing data or outlier values, such as by deleting missing or outlier values or replacing missing or outlier values with mean, median, or mode values in some situations. In other situations, missing and outlier values may be predicting using machine learning techniques discussed next and elsewhere in the present disclosure.

From feature engineering stage 406, data flow 400 can proceed to training stage 414 for constructing machine learner 418. The system can input feature vectors 412 (e.g., training samples or data points) into machine learning algorithm 416 to generate machine learner 418. As discussed, for illustrative purposes, the objective in this example is to identify a cohort to which a prospective insurance buyer belongs and suggest a policy to the prospective buyer based on his/her identified cohort. One of ordinary skill in the art will understand that this is a clustering or classification problem. If the clusters or cohorts are not known, unsupervised learning methods may be used to first define the clusters or cohorts. If there are well-defined classes, supervised learning methods may be suitable for identifying the prospective buyer's cohort.

Clustering methods include k-means clustering, hierarchical clustering, density-based clustering, grid-based clustering, and variations of these algorithms. In k-means clustering, a number of n data points are partitioned into k clusters such that each point belongs to a cluster with the nearest mean. The algorithm proceeds by alternating steps, assignment and update. During assignment, each point is assigned to a cluster whose mean yields the least within-cluster sum of squares (WCSS) (e.g., the nearest mean). During update, the new mean is calculated to be the centroids of the points in the new clusters. Convergence is achieved when the assignments no longer change. One variation of k-means clustering dynamically adjusts the number of clusters by merging and splitting clusters according to predefined thresholds. The new k is used as the expected number of clusters for the next iteration (e.g., iterative self-organizing data analysis (ISODATA)). Another variation of k-means clustering uses real data points (medoids) as the cluster centers (e.g., partitioning around medoids (PAM)).

Hierarchical clustering methods sort data into a hierarchical structure (e.g., tree, weighted graph, etc.) based on a similarity measure. Hierarchical clustering can be categorized as divisive or agglomerate. Divisive hierarchical clustering involves splitting or decomposing “central” nodes of the hierarchical structure where the measure of “centrality” can be based on “degree” centrality, (e.g., a node having the most number of edges incident on the node or the most number of edges to and/or from the node), “betweenness” centrality (e.g., a node operating the most number of times as a bridge along the shortest path between two nodes), “closeness” centrality (e.g., a node having the minimum average length of the shortest path between the node and all other nodes of the graph), among others (e.g., Eigenvector centrality, percolation centrality, cross-clique centrality, Freeman centrality, etc.). Agglomerative clustering takes an opposite approach from divisive hierarchical clustering. Instead of beginning from the top of the hierarchy to the bottom, agglomerative clustering traverses the hierarchy from the bottom to the top. In such an approach, clustering may be initiated with individual nodes and gradually combine nodes or groups of nodes together to form larger clusters. Certain measures of the quality of the cluster determine the nodes to group together at each iteration. A common measure of such quality is graph modularity.

Density-based clustering is premised on the idea that data points are distributed according to a limited number of probability distributions that can be derived from certain density functions (e.g., multivariate Gaussian, t-distribution, or variations) that may differ only in parameters. If the distributions are known, finding the clusters of a data set becomes a matter of estimating the parameters of a finite set of underlying models. EM is an iterative process for finding the maximum likelihood or maximum a posteriori estimates of parameters in a statistical model, where the model depends on unobserved latent variables. The EM iteration alternates between performing an expectation (E) step, which creates a function for the expectation of the log-likelihood evaluated using the current estimate for the parameters, and a maximization (M) step, which computes parameters maximizing the expected log-likelihood found during the E step. These parameter-estimates are then used to determine the distribution of the latent variables in the next E step.

Grid-based clustering divides a data space into a set of cells or cubes by a grid. This structure is then used as a basis for determining the final data partitioning. Examples of grid-based clustering include Wave Clustering and Statistical Information Grid (STING). Wave clustering fits the data space onto a multi-dimensional grid, transforms the grid by applying wavelet transformations, and identifies dense regions in the transformed data space. STING divides a data space into rectangular cells and computes various features for each cell (e.g., mean, maximum value, minimum value, etc.). Features of higher-level cells are computed from lower-level cells. Dense clusters can be identified based on count and cell size information.

PCA uses an orthogonal transformation to convert a set of data points of possibly correlated variables into a set of values of linearly uncorrelated variables called principal components. The number of principal components is less than or equal to the number of original variables. This transformation is defined in a manner such that the first principal component has the largest possible variance (e.g., the principal component accounts for as much of the variability in the data as possible), and each succeeding component in turn has the highest variance possible under the constraint that it is orthogonal to the preceding components. The resulting vectors are an uncorrelated orthogonal basis set.

Supervised learning methods operate on pre-labeled data. A system can acquire the pre-labeled data, classified according to predetermined criteria, to train a machine learner capable of mapping new unclassified samples to one or more classifications. Some examples of supervised learning algorithms include k-nearest neighbor (a variation of the k-means algorithm discussed above), boosting, perceptrons/neural networks, decision trees/random forests, support vector machines (SVMs), among others.

Boosting methods attempt to identify a highly accurate hypothesis (e.g., low error rate) from a combination of many “weak” hypotheses (e.g., substantial error rate). Given a data set comprising examples within a class and not within the class and weights based on the difficulty of classifying an example and a weak set of classifiers, boosting generates and calls a new weak classifier in each of a series of rounds. For each call, the distribution of weights is updated to reflect the importance of examples in the data set for the classification. On each round, the weights of each incorrectly classified example are increased, and the weights of each correctly classified example is decreased so the new classifier focuses on the difficult examples (i.e., those examples have not been correctly classified). Example implementations of boosting include Adaptive Boosting (AdaBoost), Gradient Tree Boosting, or XGBoost.

Neural networks are inspired by biological neural networks and comprise an interconnected group of functions or classifiers (e.g., perceptrons) that process information using a connectionist approach. Neural networks change their structure during training, such as by merging overlapping detections within one network and training an arbitration network to combine the results from different networks. Examples of neural network algorithms include the multilayer neural network, the auto associative neural network, the probabilistic decision-based neural network (PDBNN), and the sparse network of winnows (SNOW).

Random forests rely on a combination of decision trees in which each tree depends on the values of a random vector sampled independently and with the same distribution for all trees in the forest. A random forest can be trained for some number of trees t by sampling n cases of the training data at random with replacement to create a subset of the training data. At each node, a number m of the features are selected at random from the set of all features. The feature that provides the best split is used to do a binary split on that node. At the next node, another number m of the features are selected at random and the process is repeated.

SVMs involve plotting data points in n-dimensional space (where n is the number of features of the data points) and identifying the hyper-plane that differentiates classes and maximizes the distances between the data points of the classes (referred to as the margin).

In some examples, a system may want to optimize the make-up of clusters or classes by identifying the features and associated features to achieve a particular optimization. For example, a personal auto insurance provider may wish to identify the variables of its customer base that minimize the provider's loss ratio. One of ordinary skill in the art will understand that this can be solved using parameter estimation. Some examples of parameter estimation methods include Bayesian estimation (e.g., minimum mean square error (MMSE) estimation or maximum a posteriori (MAP) estimation, maximum likelihood estimation (MLE), etc.), fitting techniques (e.g., sum of squared difference estimation, robust estimation, etc.), and regression.

Bayesian estimation is based on Bayes' theorem for conditional probabilities, which posits that the probability of x given that z already exists or has occurred equals the probability of x and z happening together divided by the probability of z. Formally, this can be referred to as the posterior probability density function p(x|z):

p(x|z)=(p(z|x)p(x))/p(z), (Equation 4)

The optimization criterion of Bayes, minimum risk or maximum posterior expectation, is applicable when it is possible to quantify cost if estimates differ from true parameters and the expectation of the cost is acceptable as an optimization criterion. Cost function C(\hat{x}/x): [symbol] ^{M}→ [symbol] ^{N} can represent a true cost. However, it may be difficult to quantify cost accurately and it is oftentimes more practical to select a cost function whose mathematical treatment is not overly complex and to assume that the cost function depends on the difference between the estimated and true parameters, such as by computing the estimation error e=\hat{x}−x. Given these assumptions, some examples may use the minimum means square error (MMSE) estimator as a Bayesian estimator. MMSE can be formally defined as:

\hat{x}_{MMSE}z=E[x|z]=∫ₓp(x|z)dx (Equation 5)

Other examples may use the maximum a posteriori (MAP) estimator as the Bayesian estimator. MAP can be defined as:

$${\hat{x}}_{MAP} z = {arg max}_{x} \{ \frac{p ( z \text{\textbar} x ) p ( x )}{p ( x )} \} = {arg max}_{x} \{ p ( z \text{\textbar} x ) p ( x ) \} \qquad ( Equation 6 )$$

Still other examples may use maximum likelihood estimation (MLE). MLE is based on the observation that in MAP estimation, the peak of p(z|x) is when p(x) is almost constant. This can be especially true if little prior knowledge is available. In these cases, the prior density p(x) does not affect the position of the maximum very much. Discarding p(x) and maximizing the function p(z|x) leads to the MLE:

$${\hat{x}}_{MLE} z = {arg max}_{x} \{ p ( z \text{\textbar} x ) \} \qquad ( Equation 7 )$$

Data-fitting techniques model the measurement process as z=h(x)+v, where h(x) is the measurement function that models a system and v represents noise, error, and other disturbances. In data-fitting, the purpose is to find the parameter vector x that best fits the measurements z. However, if \hat{x} (e.g., a prediction) is an estimate of x, determining \hat{x} can at most predict the modeled part of z but cannot predict the disturbances. The disturbances, referred to as residuals ε, constitute the differences between observed and predicted measurements (ε=z−h(\hat{x})), and data fitting techniques identify the estimate \hat{x} that minimizes an error norm ∥ϵ∥. Different error norms can lead to different data fits.

An error norm used by some examples is the sum of squared differences (SSD) or least squared error norm (LS norm):

∥ε∥₂²=Σₙ₌₀^{N-1}εₙ²=Σₙ₌₀^{N-1}(zₙ−hₙ(\hat{x}))²=(z−h(\hat{x}))^{T}(z−h(\hat{x})) (Equation 8)

The least squares fit, or least squares estimate, is the parameter vector that minimizes the norm:

$${\hat{x}}_{L S} ( z ) = arg min \{ {( z - h ( \hat{x} ) )}^{T} ( z - h ( \hat{x} ) ) \} \qquad ( Equation 9 )$$

Other examples may use the robust error norm:

∥ε|_{robust}=Σₙ₌₀^{N-1}ρ(εₙ)=Σₙ₌₀^{N-1}ρ(zₙ−hₙ(\hat{x})), (Equation 10)

where ρ(x) measures the size of each individual residual zₙ−hₙ(\hat{x}). The robust error norm may be preferred to the LS norm when there are a small number of large measurement errors or outliers and the influence of these outliers are overdetermined in view of errors being weighted quadratically. The robust error norm can operate as the bounds for the outliers.

Regression attempts to determine an empirical function that defines a data set. Regression analyzes pairwise measurements t, a measurement without any appreciable error referred to as the independent variable, and z, a prediction arising from t. It assumes that some empirical function f(x) can predict z from the independent variable t. Regression also posits that a parameter vector x can be used to control the behavior of f(x). Thus, regression can be modeled as z=f(t,x)+ε, where f(x) is the regression function, and ε is the residual (e.g., the part of z that cannot be predicted by f (x)). The residual can originate from noise or other sources of randomness, which can make the prediction uncertain. However, the residual can also be caused by an inadequate choice of the regression curve. A goal of regression is to determine an estimate of the parameter vector x based on N observations (tₙ, zₙ) for n=0 . . . , N−1 that minimizes the residuals εₙ. The observations zₙ can be stacked in a vector z, and the problem of finding 2 can be given as:

$$z = h ( \hat{x} ) + ɛ with z {=}^{def} [ \begin{matrix}{z}_{0} \\ ⋮ \\ {z}_{n - 1}\end{matrix} ] , \\ h ( x ) {=}^{def} [ \begin{matrix}f ( {t}_{0} , x ) \\ f ( {t}_{N - 1} , x )\end{matrix} ] , and ɛ {=}^{def} [ \begin{matrix}{ɛ}_{0} \\ ⋮ \\ {ɛ}_{n - 1}\end{matrix} ] , \qquad ( Equation 11 )$$

where ε is the vector that embodies the residuals ϵₙ. Since the model is in the standard form, x can be estimated with a least squares approach. Alternatively, robust regression analysis may be used to minimize the robust error norm.

After completion of training phase 402, the system can process new samples in labeling phase 420 beginning with data ingestion stage 422. At this stage, the system can receive new data from data streams 302α, 302β, . . . , 302ω (collectively, 302′) and process the new data in a similar or the same manner as data ingestion stage 402a. Data flow 400 may continue on to feature engineering stage 426 to extract new features 428 and associated feature values 430 to build new feature vectors 432. Feature engineering stage 426 may use the same or similar underlying techniques as feature engineering stage 406. By the time of execution of labeling phase 420, the system has built machine learner 418 such that the system can provide new feature vectors 432 as input to machine learner 418 during labeling stage 434. Machine learner 418 can output a cluster, classification, label, or other output data computed by inputting new feature vectors 432 into machine learner 418.

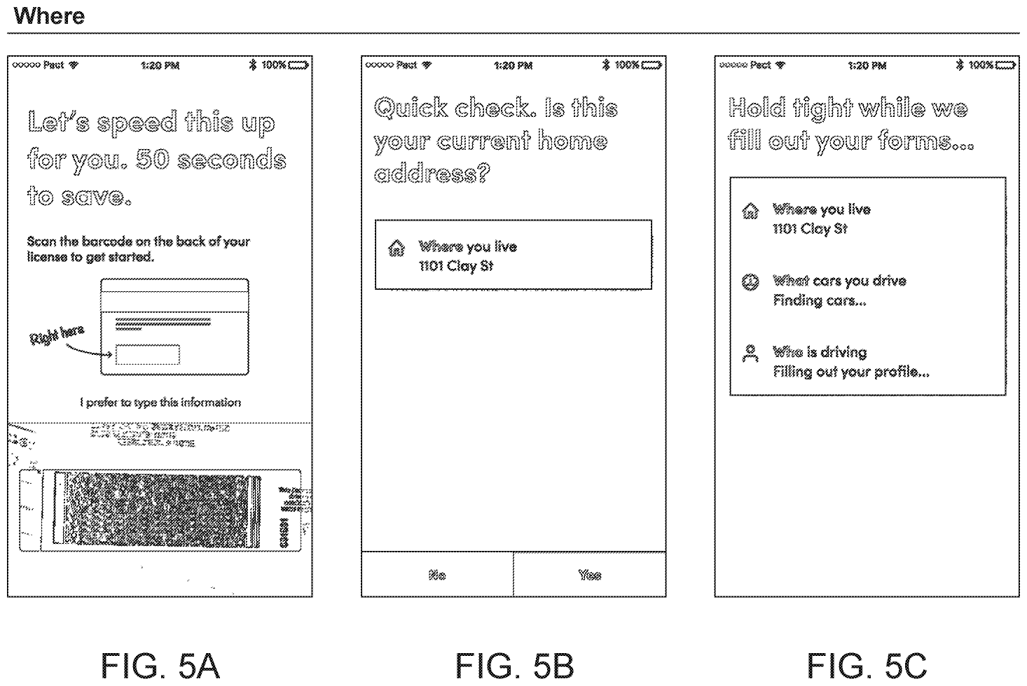

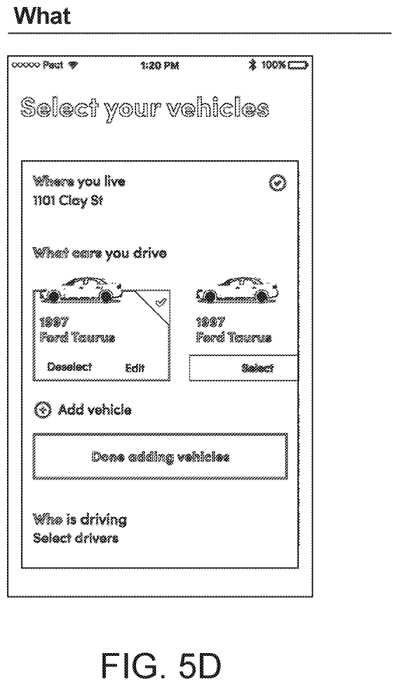

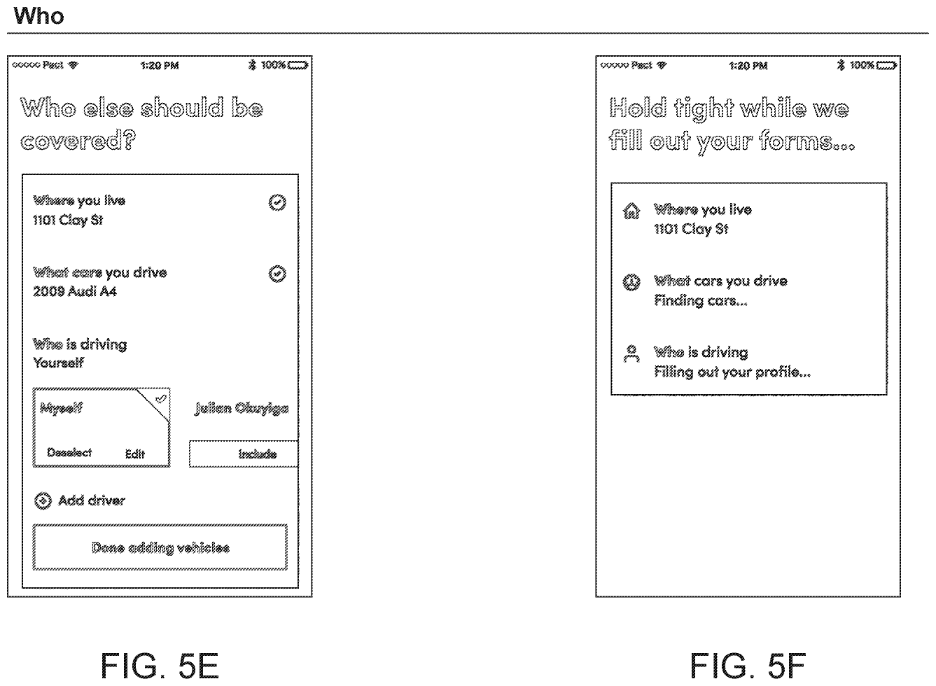

FIG. 5A-5F show examples of graphical user interfaces for a network-based application for providing dynamic resource-sharing services. In these examples, the graphical user interfaces can be part of a standalone, native mobile application or app for a particular mobile operating system (e.g., Apple iOS® or Google Android®). Other examples may present the graphical user interfaces on standalone, native applications for other mobile operating systems or desktop operating systems (e.g., Microsoft Windows®, LINUX®, Apple Mac OS X®, etc.). Still other examples can present the graphical user interfaces via web browsers for desktops (e.g., Microsoft Explorer®, Chrome® for Google Android®, Mozilla Firefox®, etc.) or mobile devices (e.g., Google Chrome®, Safari® for Apple iOS®, etc.), native applications for desktop computers. Still other examples may present interfaces that have no graphical elements (e.g., voice interfaces) or machine-to-machine interfaces (e.g., representational state transfer (REST) application programming interfaces (APIs), Simple Object Access Protocol (SOAP), Service Oriented Architecture (SOA), microservices, other APIs, and other machine-to-machine interfaces).

FIG. 5A is a user interface diagram showing a barcode scanning interface, according to some examples, presented by a client application (e.g., native client application 716), that enables a user to conveniently input image data that includes a machine code (e.g., a barcode) to a client device (e.g., client device 710). The barcode scanning interface includes a first interface portion, which provides instructions to a user regarding the barcode scanning process, while a second interface portion is used by a camera function of the client device 710 to enable the native client application 716 to capture the image data. In some examples, the image data is then received and decoded by the client device 710 to reveal the number embedded in the barcode, and this number is then communicated to a server system (e.g., application server 718), where the number is used to identify a user associated with the client device 710. In other examples, the captured image data itself is communicated from the client device 710 to the application server 718, where the decoding of the image data is performed in order to reveal a number, that is then used to identify the relevant user.

FIG. 5B is a user interface diagram showing an address confirmation interface, according to some examples, presented by the native client application 716. The address confirmation interface presents an address, or at least partial address information to the user that is retrieved by the application server 718, based on the identified user, and communicated to the client device 710 for presentation by the native client application 716. The address confirmation interface is useful for confirming that the correct user has, in fact, been identified, based on the barcode scanned using the barcode scanning interface.

FIG. 5C is a user interface diagram showing a hold interface, according to some examples, again presented by the native client application 716. The hold interface provides a progress report to a viewing a user of the client application about profile information that is being retrieved, for example, by the application server 718, based on the identity of the user established using the scanned barcode. Specifically, the hold interface indicates that the application server 718 is identifying the vehicles (e.g., cars) driven by the user, and is also completing a profile for the user that will be constructed and maintained by the application server 718. This profile information is retrieved from various public sources and databases, such as public Department of Motor Vehicles records, credit reporting agencies, etc.

FIG. 5D is a user interface diagram showing a vehicle selection interface, according to some examples, presented by the client application 716. The vehicle selection interface provides information identifying a set of vehicles that have been identified by the application server 718 as being associated with (e.g., owned by, leased by, or otherwise driven by), the relevant user. A graphic element, in the form of an icon, is presented within the vehicle selection interface together with a selection mechanism, which includes a select button, a deselect button and an edit button. Using the selection mechanism, the user can indicate which vehicles are to be added to a temporary policy for the user.

Having selected vehicles in the selection interface, the user is then presented with a driver selection interface, an example of which is shown in FIG. 5E. The driver selection interface provides information identifying a set of potential drivers, again identified by the application server 718, this set of drivers including the primary user, as well as any other identified users that may be associated with the primary user. For example, such other users may be family members, cohabitators, or friends that share a particular vehicle. Again, a graphic element, in the form of a card, is presented within the driver selection interface for each user, together with a selection mechanism. Using the selection mechanism, the primary user can indicate which users (e.g., drivers) are to be added to the temporary policy for the user.

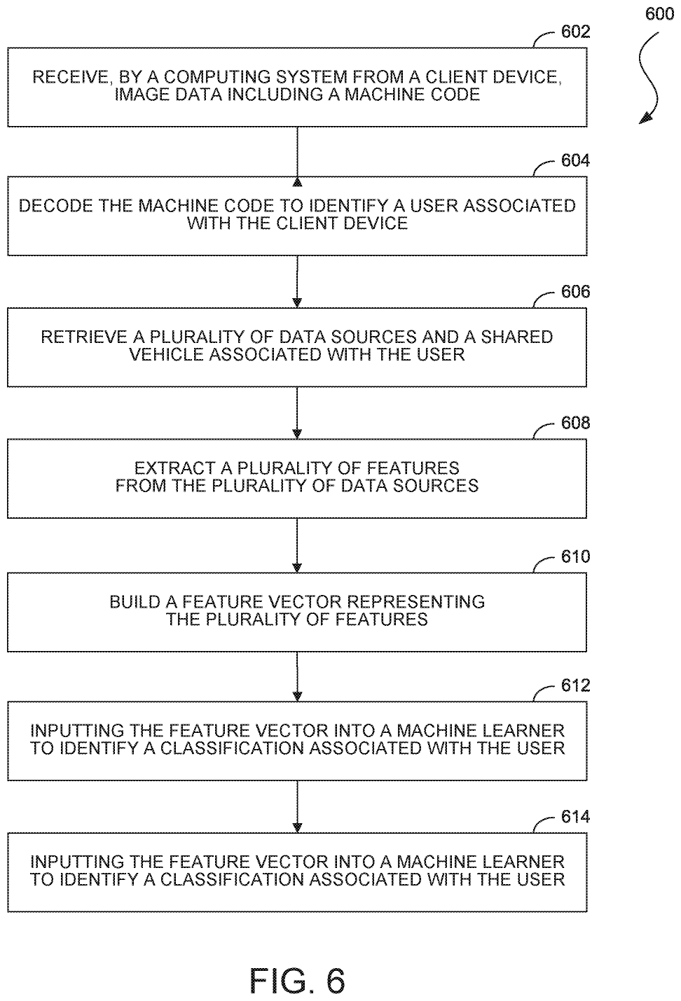

FIG. 5F is a user interface diagram showing a further hold interface, according to some examples, which is again presented by the client application 716 to the user while the profile for the primary user, to be used in generating a feature vector, is collected, compiled, processed and stored. FIG. 6 shows an example method 600, for providing dynamic network-based resource-sharing services. For illustrative purposes, a computing system for providing online personal auto insurance can perform method 600 but one of ordinary skill in the art will appreciate that other examples may use other types of network-based applications and services to perform method 600. In addition, there can be additional, fewer, or alternative operations performed or stages that occur in similar or alternative orders, or in parallel, within the scope of various examples unless otherwise stated.

The method 600 commences at operation 602, with the receipt, by a computing system (e.g., the client device 710 or the application server 718), of image data including a machine code. In some examples, the image data is a photograph of a driver's license bearing a bar code that is captured by a camera of the client device 710 and communicated to the native client application 716. The capturing of the photograph of the driver's license is performed using the barcode scanning interface of the native client application 716 described with reference to FIG. 5A. The photograph of the driver's license may be processed by the native client application 716 to identify and isolate that portion of the image that includes the barcode, and this portion of the image is communicated from the native client application 716 to the application server 718.

At operation 604, the machine code, in the form of the barcode reflected in the photograph of the driver's license, is decoded to identify a user associated with the client device 710. This decoding is done, in some examples, at the application server 718 and/or at the native client application 716. For example, some high-level decoding may be performed by the native client application 716, before transmitting of the image data to the application server 718. In other examples, all of the processing involved in the decoding application may be done at either the native client application 716, or at the application server 718.

At operation 606, multiple data sources (e.g., public DMV records, social media networks, and other public databases) are accessed to retrieve data source information associated with the user, and a shared vehicle associated with the user. To this end, the application server 718 may use the identity information for the user, decoded at operation 604, to query these databases. Further, the application server 718 may use the vehicle identification information, for example received via the vehicle selection interface described with reference to FIG. 5D, in order to retrieve data regarding the relevant vehicle from multiple data sources (e.g., DMV databases, social networking databases, credit agency databases, and also profile and other data stored on the client device 710). Further examples of information retrieval from various data sources is described above with reference to FIG. 4. The retrieved data may include mobile sensor data, driver data, vehicle data, credit data and social network data. Of course, this data is retrieved, processed, transmitted and shared with full authorization and disclosure to the user, and the user is presented with the option to exclude any data sources from the retrieval operation 606.

At operation 608, the application server 718 extract a number of features from the data retrieved at operation 606. As described herein, these features may include Boolean features, numeric features, date features, text features, image features and application-specific features. Further details regarding example features are discussed above with reference to FIG. 4 and the feature engineering stage 406 of the data flow 400.

At operation 610, the application server 718 generates a feature vector representing the features extracted at operation 608. Further details regarding feature vectorization, according to some examples, is discussed above with reference to FIG. 4.

At operation 612, the application server 718 inputs the feature vector into a machine learner to generate a classification associated with the user. Further details regarding various aspects of the classification process, according to some examples, are discussed above with reference to FIG. 4. Specifically, a machine learner, which forms part of the application server 718, may generate a classification using a training phase and labeling phase, with the machine learner having received labeled training data during the training phase. The machine learner then generates the classification of the user based on rules generated during the training phase, and applied to the feature vector.

At operation 614, the application server 718 generates and transmits a dynamic insurance policy to a user, based on the classification generated at operation 618. The dynamic insurance policy may be presented to the user via an appropriate interface of the native client application 716, and the user may be presented with the option to either accept the terms and conditions of the dynamic insurance policy, or modify certain parameters (e.g., duration, deductibles etc.) in order to generate a modified insurance policy.

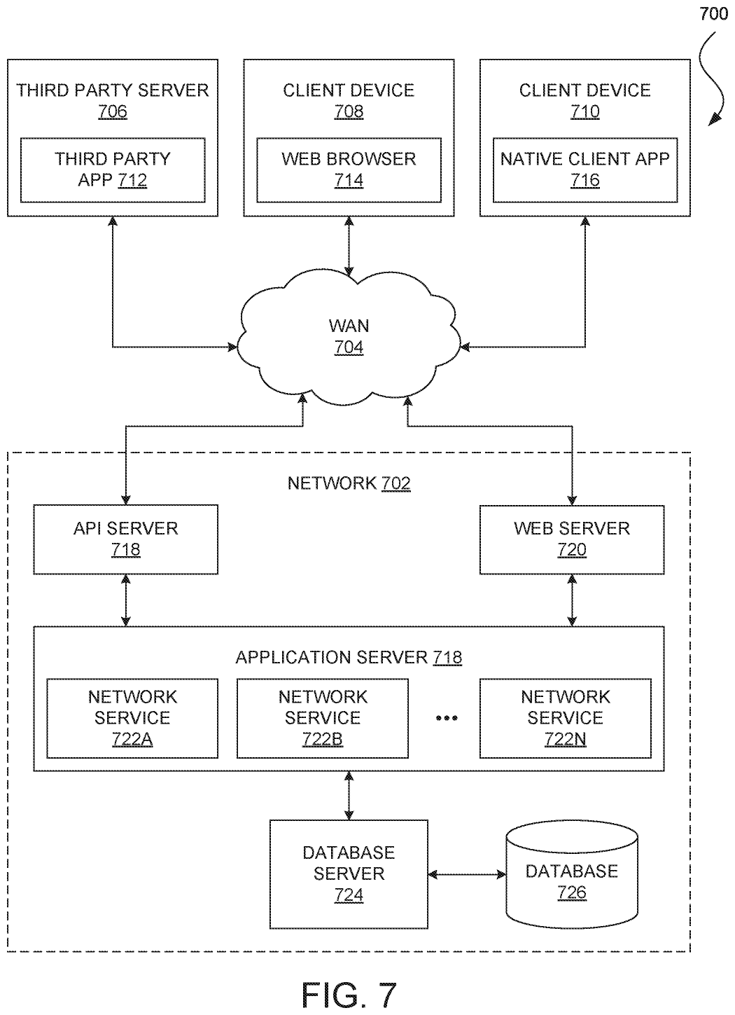

The method 600 may include a looping function, whereby operations 606-614 may be looped in order to identify changes in the data retrieved from the multiple data sources, to update feature vector based on these changes to generate an updated classification, and to update the policy for the user based on this updated classification. FIG. 7 shows an example of a network architecture, network architecture 700, in which various examples of the present disclosure may be deployed. In this example, network architecture 700 includes network-based service or application 702, wide area network (WAN) 704 (e.g., the Internet), third-party server 706, client device 708, and client device 710. Network-based service or application 702 can provide online personal auto insurance services to third-party server 706, client device 708, and client device 710 over WAN 704. Users (e.g., vehicle owners, vehicle borrowers, etc.) may interact with network-based service or application 702 using third-party application 712 (e.g., applications that interface with an API, such as an API provided by Tulip Insurance Services™ of Palo Alto, Calif.), web browser 714 (e.g., Microsoft Internet Explorer®, Google Chrome®, Mozilla Firefox®, Apple Safari®, etc.), or native application 716 (e.g., Tulip™ mobile app for Google Android®, Apple iOS®, etc.) executing on third-party server 706, client device 708, and client device 710, respectively. Although each of third-party server 706, client device 708, and client device 710 are shown executing one application to interact with network-based service or application 702, each includes third-party application 712, web browser 714, native application 716, or some combination of these applications.

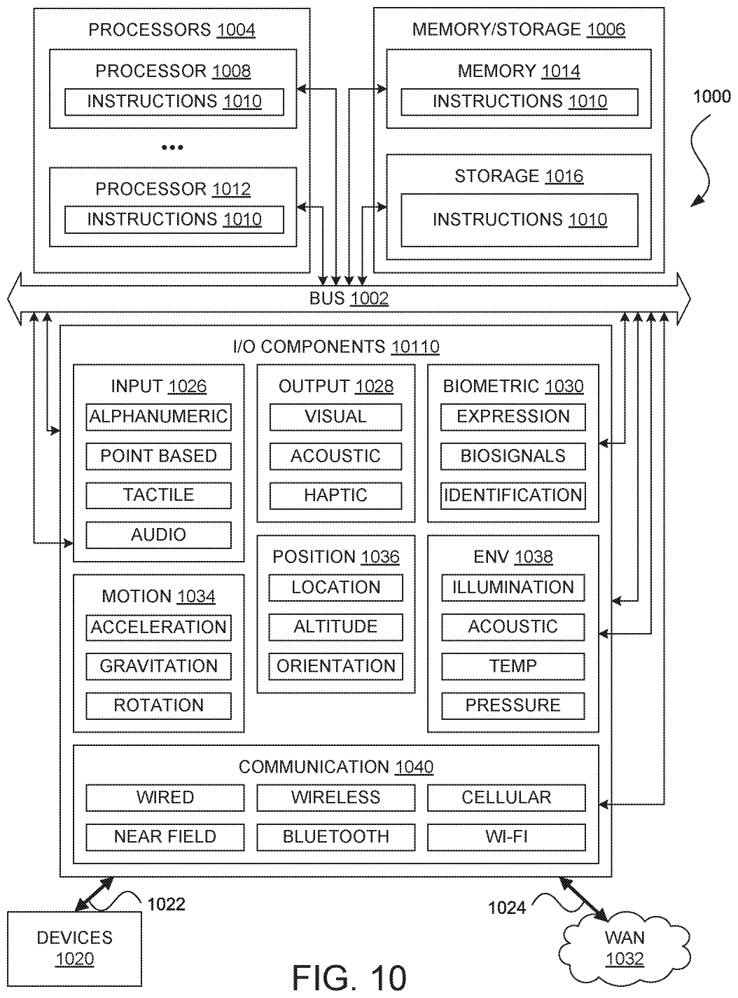

Some examples of client devices 708 and 710 include servers, desktop computers, mobile phones, smart phones, tablets, ultra-books, netbooks, laptops, multi-processor systems, microprocessor-based or programmable consumer electronics, game consoles, set-top boxes, or any other communication device that a user may use to access network-based service or application 702. An example of an implementation of client device 708 and/or 710 is discussed further below with respect to FIG. 10.

Application program interface (API) server 718 and web server 720 may be coupled to, and provide programmatic and web interfaces respectively to, application server 718. Application server 718 may host network-based components 722A, 722B, . . . , 722N (collectively, 722), each of which may comprise one or more modules or applications embodied as hardware, software, firmware, or any combination thereof to provide various services offered by network-based application or service 702. Application server 718 may connect to database server 724 to access information storage repository or database 726. Database 726 can store user accounts, underwriting data, policies, premium and payment information, vehicle information, and other data managed and maintained by an online personal auto insurance provider.

Web browser 714 can access network-based components 722 via a web interface supported by web server 720. Similarly, native client application 716 can access the various services and functions provided by network-based service or application 702 via the programmatic interface provided by API server 718. In some examples, native client application 516 may be a mobile app to enable users to receive a personal auto insurance quote, establish a personal auto insurance policy, manage their policies, and perform other tasks related to their policies online.

Additionally, third-party application 712, executing on a third-party server 706, may have programmatic access to network-based service or application 702 via the programmatic interface provided by API server 718. For example, third-party application 712, utilizing information retrieved from network-based service or application 702, may support one or more features or functions on a website hosted by the third-party. The third-party website may provide one or more promotional, analytic, or payment functions that are supported by network-based service or application 702.

FIG. 8 shows an example of services 800 that can be deployed in an embodiment of the present disclosure. For illustrative purposes, services 800 can provide certain functionality for an online personal auto insurance provider, such as reviewing policies available for purchase for vehicle owners and vehicle buyers, managing existing policies, purchasing on-demand policies, and the like. Hosts of services 800 may be physically located on-premises (e.g., hosted within one or more data centers owned or leased by an enterprise), off-premises (e.g., hosted by a public cloud provider, data center provider, etc.), or both (e.g., hosted using a hybrid cloud environment). Thus, services 800 can run in dedicated or shared servers that are communicatively coupled to enable communications between the servers. The services themselves can be communicatively coupled (e.g., via appropriate interfaces) to each other and to various data sources to allow information to be passed between the services or allow the services to share and access common data.

In this example, services 800 include on-boarding service 802, owner quote service 804, sharer quote service 806, risk analysis service 808, forecasting service 810, policy issuance service 812, claims processing service 814, premium collection service 816, risk mitigation service 818, fraud prevention service 820, telematics service 822, photogrammetric service 824, valuation service 826, and chatbot 828, among other network-based applications and services. One of ordinary skill in the art will appreciate that other examples may use different sets of services, including configurations with more services, fewer services, or alternative services, for providing online personal auto insurance.

In some examples, on-boarding service 802 can achieve download to quote to policy issuance in under a minute and more than 15 times faster than conventional system. On-boarding service 802 can provide such performance by replacing manual input with driver's license and other document scanning, audio input, and other types of input methods. In addition, on-boarding service 802 can improve over a conventional system by replacing physical agents with administrative artificial intelligences, such as

Owner quote service 804 can provide a personal auto insurance quote to a vehicle owner in real-time. In an embodiment, owner quote service 804 can present a qualified user with a preferred step-down policy that provides coverage to the named driver(s) listed on the policy. If a driver is unlisted or hidden, physical damage coverage can be removed, and liability coverage limits can be reduced to those mandated by state financial responsibility requirements. The step-down mechanism can provide a clean underwriting sandbox that removes assumptions around permissive-use. Administrating claims is simplified relative to conventional systems.

Sharer quote service 806 can provide an occasional auto insurance quote to a user who may own his/her own vehicle but has been authorized to borrow a car owner's vehicle. In some examples, sharer quote service 806 can provide a qualified user with an on-demand auto insurance policy quoted and issued through a web interface (e.g., web browser, native application or app). The policy can be an instant, comprehensive policy that covers the borrower. Owners can require borrowers to purchase the on-demand policy. Borrowers may also book insurance in advance for limited durations as short as an hour or as long as 6 months. Sharing Policy rates can be developed from the filings of publicly-traded personal auto insurance providers. The Sharing Policy can be underwritten based on the permutation of driver risk characteristics (derived from a suite of reports), vehicle risk characteristics, and contextual rating factors (e.g. territory, time of day). By virtue of an owner requiring borrowers to book Sharing Policy coverage, the vehicle owner can reap the economic benefit of the step-down coverage. Further, owners may be granted peace of mind from knowing they can lend their vehicles without concerns around liability.

Risk mitigation service 808 includes control processes that emphasize data collection and machine learning processes that employ a systematic approach to data analysis. Before issuance, the system can weed out material misrepresentation. For example, the system can require drivers' licenses to procure quotes, and the system can run reports for driver history, coverage verification, risk analysis, and credit history, among other data sources.

As part of the customer intake process, some examples can query several third-party providers to build an underwriting profile for owners, vehicles, and sharers. For example, the loss history report can provide a seven-year history of automobile insurance losses associated with an individual, identifying for each loss: the date of loss, loss type, and amount paid along with policy number, claim number and insurance company name; and Policy History and Coverage Lapse Information can provide policy-level information about the owner of the vehicle helpful for fraud prevention.

Concurrently, the system can monitor quoting behavior. For example, if a user toggles back and forth amongst quoting inputs in order to find cheapest rates, the user will not be able to purchase an insurance policy through the web interface. The system will require the user consumer will be required to speak to a licensed agent in order to be issued a policy. Thus, the system can be designed to mitigate material misrepresentation from inception.

Forecasting service 810 includes predictive analytical tools for generating forecasts relating to the business of the system, such as premium forecasts.

Policy issuance service 812 issues and transmits a personal auto insurance policy to a user and enables the user to manage his/her policy, including whether to allow other users to borrow the vehicle and to require them to purchase a Sharing Policy when borrowing the vehicle.

Claims processing service 814 includes a management system for users to make insurance claims against their insurance policies, check the status of claims, and otherwise manage their claims.

Premium collection service 816 enables users to make payments for their personal auto insurance policies, establish automatic payments, and generally manage payments.

Risk analysis service 818 includes tools for analyzing the risk of offering a Sharing Policy to a user. For example, as the final step before a Sharing Policy is bound, the system can require drivers to document the condition of the vehicle with photos. This can help the system combat fraud by creating a record of truth documenting the condition of the vehicle at the moment coverage begins. After a policy is bound, the system can continue to employ innovative risk mitigation techniques to adequately price the on-demand Sharing Policy. Table 2 sets forth examples of the data analyzed in real-time to determine whether to grant a Sharing Policy.

TABLE 2
Example criteria for Sharing Policy

| Classification | Description/Rejection criteria |
|---|---|
| Territory | Most recent or rounded location |
| Age/Years licensed | Driver must be over 18 with a valid license |
| Major moving | Automatically retrieve and analyze major violations |
| violations | |
| Minor moving | Automatically retrieve and analyze minor violations |
| violations | |
| Vehicle Model Year | Must be less than twenty-five years old |
| Vehicle Symbol | Automatically retrieve and analyze vehicle symbols |
| | for comprehensive and collision coverages |
| Time of day | Increases and decreases exposure dependent on risk |
| Duration | Usage rates influenced by duration |

Fraud prevention service 820 can implement fraud detection and prevention mechanisms to reduce the occurrence of fraud in the field of personal auto insurance. In some examples, a system practicing the techniques of the present disclosure can dashboard package information so adjusters can quickly triage claims to Special Investigation Units (SIU). The follow examples can trigger SIU:
Losses in first 30 days;
Theft and vehicle arson;
Theft of higher MSRP vehicles;
Claims involving two older vehicles;
Multiple passengers; and
Claims occurring between 11 pm-5 am local time with no police report.

In some examples, SIU can leverage data sources from claims history, license plate lookup; identification information such as addresses, phone numbers, social security numbers, and driver's license numbers; social media searches; and crime databases.

In some examples, machine learning may also be deployed for fraud prevention. In one example, fraud prevention includes a four-step data analysis pipeline that brings a sophisticated and systematic approach to combat fraud by using the latest advances in link analysis, signal processing, and photogrammetry. The fraud prevention pipeline includes profiling, analysis, scoring, and alerts and reports.

The fraud prevention pipeline can begin with building of fraud profiles for each policy-holder. The profiling process can start with learning user behaviors by integrating data from mobile device sensors. The system can then generate unique user profiles based on personal activities and habits. Further, the system can use social media data sources to extract general sentiment and identify potential risk factors.

In some examples, the system can also be designed to process copious amounts of structured and unstructured data. The analytics engine can employ up-to-date graph database technologies to perform link analysis and help identify possible fraud rings alongside partners. In addition, photogrammetry algorithms can allow examiners to quickly evaluate photos and verify actual damages and causes of the damages.

In some examples, the system can generate risk scores by combining user profiles with Open Source Intelligence data and link analyses. The score can be generated whenever a policy is bound and may be continuously updated when new data is available.

In some examples, possible fraud signals such as behavior anomalies, sentiment change, and other alerts generated at binding can be automatically streamed to adjustors in real-time to defeat potential fraud.

In some examples, the system includes telematic services 822 in mobile devices (e.g., tablets, mobile phones, wearable user devices, etc.) or small-factor, in-car devices to monitor and detect speeding, hard braking, and hard cornering without relying on unwieldy onboard diagnostic (OBD) devices. Mobile sensors can provide granular insight into risk profiles beyond what is gained from underwriting data reports. Contextual data can be fed into machine learning algorithms that enable the system to cluster Sharing Policy drivers into different risk buckets. In addition, the system can measure phone usage behind the wheel using proximity sensors, accelerometer metrics, and low-level system programming to measure phone usage.

Photogrammetry service 824 includes machine vision tools to allow examiners to quickly evaluate photos and verify actual damages and causes of the damages.

Valuation service 826 includes tools for assessing the value of a user's vehicle.

Chatbot 828 can comprise an artificial intelligence system trained to answer user queries regarding their insurance policies and to help users manage their policies.

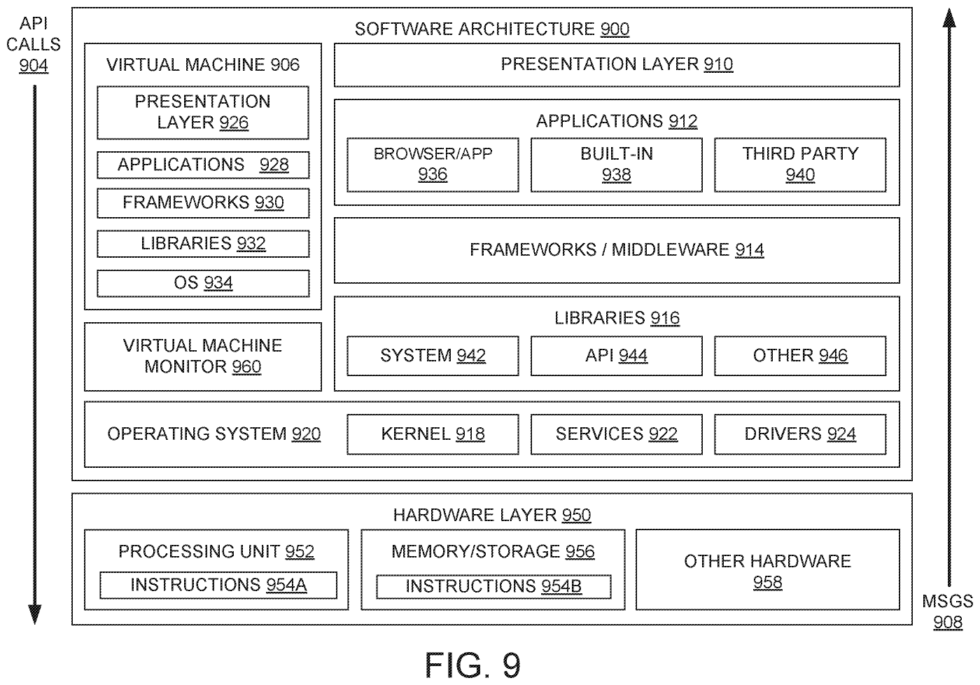

FIG. 9 shows an example of software architecture 900 that various hardware devices described in the present disclosure can implement. Software architecture 900 is merely one example of a software architecture for implementing various examples of the present disclosure and other examples may use other software architectures to provide the functionality described herein. Software architecture 900 may execute on hardware, such as computing system 1000 of FIG. 10. Hardware layer 950 can represent a computing system, such as computing system 1000 of FIG. 10. Hardware layer 950 includes one or more processing units 952 having associated executable instructions 954A. Executable instructions 954A can represent the executable instructions of software architecture 900, including implementation of the methods, processes, flows, systems, models, libraries, managers, applications, or components described herein. Hardware layer 950 can also include memory and/or storage modules 956, which also have executable instructions 954B. Hardware layer 950 may also include other hardware 958, which can represent any other hardware, such as the other hardware illustrated as part of computing system 800.

In the example of FIG. 9, software architecture 900 may be conceptualized as a stack of layers in which each layer provides particular functionality. For example, software architecture 900 includes layers such as operating system 920, libraries 916, frameworks/middleware 914, applications 912, and presentation layer 910. Operationally, applications 912 and/or other components within the layers may invoke API calls 904 through the software stack and receive a response, returned values, and so forth as messages 908. The layers illustrated are representative in nature and not all software architectures have all layers. For example, some mobile or special-purpose operating systems may not provide a frameworks/middleware layer 914, while others may provide such a layer. Other software architectures includes additional or different layers.

Operating system 920 may manage hardware resources and provide common services. In this example, operating system 920 includes kernel 918, services 922, and drivers 924. Kernel 918 may operate as an abstraction layer between the hardware and the other software layers. For example, kernel 918 may be responsible for memory management, processor management (e.g., scheduling), component management, networking, security settings, and so on. Services 922 may provide other common services for the other software layers. Drivers 924 may be responsible for controlling or interfacing with the underlying hardware. For instance, drivers 924 includes display drivers, camera drivers, Bluetooth drivers, flash memory drivers, serial communication drivers (e.g., Universal Serial Bus (USB) drivers), Wi-Fi drivers, audio drivers, power management drivers, and so forth depending on the hardware configuration.

Libraries 916 may provide a common infrastructure that may be used by applications 912 and/or other components and/or layers. Libraries 916 typically provide functionality that allows other software modules to perform tasks in an easier fashion than to interface directly with the underlying operating system functionality (e.g., kernel 918, services 922, and/or drivers 924). Libraries 916 includes system libraries 942 (e.g., C standard library) that may provide functions such as memory allocation functions, string manipulation functions, mathematic functions, and the like. In addition, libraries 916 includes API libraries 944 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D graphics for display), database libraries (e.g., SQLite that may provide various relational database functions), web libraries (e.g., WebKit that may provide web browsing functionality), and the like. Libraries 916 may also include a wide variety of other libraries 946 to provide many other APIs to applications 912 and other software components/modules.

Frameworks 914 (sometimes also referred to as middleware) may provide a higher-level common infrastructure that may be used by applications 912 and/or other software components/modules. For example, frameworks 914 may provide various graphic user interface (GUI) functions, high-level resource management, high-level location services, and so forth. Frameworks 914 may provide a broad spectrum of other APIs that may be used by applications 912 and/or other software components/modules, some of which may be specific to a particular operating system or platform.

Applications 912 includes web browser or native client application 936, built-in application 938, and/or third-party application 940. Some examples of built-in application 938 include a contacts application, a browser application, a book reader application, a location application, a media application, a messaging application, and/or a game application. Third-party application 940 includes any application developed by an entity other than the vendor of the host operating system or platform, such as desktop software running on Microsoft Windows®, UNIX®, LINUX®, Apple Mac OS X®, or other suitable desktop operating system; or mobile software running on a mobile operating system such as Apple iOS®, Google Android®, Microsoft Windows Phone®, or other mobile operating system. In this example, third-party application 940 may invoke API calls 904 provided by operating system 920 to facilitate functionality described herein.

Applications 912 may use built-in operating system functions (e.g., kernel 918, services 922, and/or drivers 924), libraries (e.g., system libraries 942, API libraries 944, and other libraries 946), or frameworks/middleware 914 to create user interfaces to interact with users of the system. Alternatively, or in addition, interactions with a user may occur through presentation layer 910. In these systems, the application/module “logic” can be separated from the aspects of the application/module that interact with a user.

Some software architectures use virtual machines. In the example of FIG. 9, this is illustrated by virtual machine 906. A virtual machine creates a software environment where applications/modules can execute as if they were executing on a physical computing device (e.g., computing system 800 of FIG. 8). Virtual machine 906 can be hosted by a host operating system (e.g., operating system 920). The host operating system typically has a virtual machine monitor 960, which can manage the operation of virtual machine 906 and the interface with the host operating system (e.g., operating system 920). A software architecture executes within virtual machine 906, and includes operating system 934, libraries 932, frameworks/middleware 930, applications 928, and/or presentation layer 926. These layers executing within virtual machine 906 can operate similarly or differently to corresponding layers previously described.

FIG. 10 shows an example of a computing system, computing system 1000, in which various examples may be implemented. In this example, computing system 1000 can read instructions 1010 from a computer-readable medium (e.g., a computer-readable storage medium) and perform any one or more of the methodologies discussed herein. Instructions 1010 include software, a program, an application, an applet, an app, or other executable code for causing computing system 1000 to perform any one or more of the methodologies discussed herein. For example, instructions 1010 may cause computing system 1000 to execute method 600 of FIG. 6. Alternatively or in addition, instructions 1010 may implement the methods, processes, flows, systems, models, libraries, managers, applications, or components thereof set forth in FIGS. 1A-1C, 2, and 3A-3D; client applications 512, 514, and 516 or server 520 of FIG. 5; the system 400 of FIG. 4, software architecture 900 of FIG. 9, and so forth. Instructions 1010 can transform a general, non-programmed computer, such as computing system 1000 into a particular computer programmed to carry out the functions described herein.

In some examples, computing system 1000 can operate as a standalone device or may be coupled (e.g., networked) to other devices. In a networked deployment, computing system 1000 may operate in the capacity of a server or a client device in a server-client network environment, or as a peer device in a peer-to-peer (or distributed) network environment. Computing system 1000 includes a server, a workstation, a desktop computer, a laptop computer, a tablet computer, a netbook, a set-top box (STB), a personal digital assistant (PDA), an entertainment media system, a cellular telephone, a smart phone, a mobile device, a wearable device (e.g., a smart watch), a smart home device, other smart devices, a web appliance, a network router, a network switch, a network bridge, or any electronic device capable of executing instructions 1010, sequentially or otherwise, that specify actions to be taken by computing system 1000. Further, while a single device is illustrated in this example, the term “device” shall also be taken to include a collection of devices that individually or jointly execute instructions 1010 to perform any one or more of the methodologies discussed herein.

Computing system 1000 includes processors 1004, memory/storage 1006, and I/O components 1018, which may be configured to communicate with each other such as via bus 1002. In some examples, processors 1004 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio frequency integrated circuit (RFIC), another processor, or any suitable combination thereof) includes processor 1008 and processor 1012 for executing some or all of instructions 1010. The term “processor” is intended to include a multi-core processor that may comprise two or more independent processors (sometimes also referred to as “cores”) that may execute instructions contemporaneously. Although FIG. 10 shows multiple processors 1004, computing system 1000 includes a single processor with a single core, a single processor with multiple cores (e.g., a multi-core processor), multiple processors with a single core, multiple processors with multiples cores, or any combination thereof.

Memory/storage 1006 includes memory 1014 (e.g., main memory or other memory storage) and storage 1016 (e.g., a hard-disk drive (HDD) or solid-state device (SSD) may be accessible to processors 1004, such as via bus 1002. Storage 1016 and memory 1014 store instructions 1010, which may embody any one or more of the methodologies or functions described herein. Instructions 1010 may also reside, completely or partially, within memory 1014, within storage 1016, within processors 1004 (e.g., within the processor's cache memory), or any suitable combination thereof, during execution thereof by computing system 1000. Accordingly, memory 1014, storage 1016, and the memory of processors 1004 are examples of computer-readable media.

As used herein, “computer-readable medium” means an object able to store instructions and data temporarily or permanently and includes random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “computer-readable medium” includes a single medium or multiple media (e.g., a centralized or distributed database, or associated caches and servers) able to store instructions 1010. The term “computer-readable medium” can also include any medium, or combination of multiple media, that is capable of storing instructions (e.g., instructions 1010) for execution by a computer (e.g., computing system 1000), such that the instructions, when executed by one or more processors of the computer (e.g., processors 1004), cause the computer to perform any one or more of the methodologies described herein. Accordingly, a “computer-readable medium” can refer to a single storage apparatus or device, “cloud-based” storage systems or storage networks that include multiple storage apparatus or devices, or a system in between these configurations. The term “computer-readable medium” excludes signals per se.

I/O components 1018 includes a wide variety of components to receive input, provide output, produce output, transmit information, exchange information, capture measurements, and so on. The specific I/O components included in a particular device will depend on the type of device. For example, portable devices such as mobile phones will likely include a touchscreen or other such input mechanisms, while a headless server will likely not include a touch sensor. In some examples, I/O components 1018 includes output components 1026 and input components 1028. Output components 1026 includes visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. I/O components 1018 includes alphanumeric input components (e.g., a keyboard, a touch screen configured to receive alphanumeric input, a photo-optical keyboard, or other alphanumeric input components), pointer-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In some examples, I/O components 1018 may also include biometric components 1030, motion components 1034, position components 1036, or environmental components 1038, or among a wide array of other components. For example, biometric components 1030 includes components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. Motion components 1034 includes acceleration sensor components (e.g., accelerometer), gravitation sensor components, rotation sensor components (e.g., gyroscope), and so forth. Position components 1036 includes location sensor components (e.g., a Global Position System (GPS) receiver component), altitude sensor components (e.g., altimeters or barometers that detect air pressure from which altitude may be derived), orientation sensor components (e.g., magnetometers), and the like. Environmental components 1038 includes illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment.

Communication may be implemented using a wide variety of technologies. I/O components 1018 includes communication components 1040 operable to couple computing system 1000 to WAN 1032 or devices 1020 via coupling 1024 and coupling 1022 respectively. For example, communication components 1040 includes a network interface component or other suitable device to interface with WAN 1032. In some examples, communication components 1040 includes wired communication components, wireless communication components, cellular communication components, Near Field Communication (NFC) components, Bluetooth components (e.g., Bluetooth Low Energy), Wi-Fi components, and other communication components to provide communication via other modalities. Devices 1020 may be another computing device or any of a wide variety of peripheral devices (e.g., a peripheral device coupled via USB).

Moreover, communication components 1040 may detect identifiers or include components operable to detect identifiers. For example, communication components 1040 includes radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via communication components 1040, such as location via Internet Protocol (IP) geolocation, location via Wi-Fi signal triangulation, location via detecting an NFC beacon signal that may indicate a particular location, and so forth.

In various examples, one or more portions of WAN (Wide Area Network) 1032 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi network, another type of network, or a combination of two or more such networks. For example, WAN 1032 or a portion of WAN 1032 includes a wireless or cellular network and coupling 1024 may be a Code Division Multiple Access (CDMA) connection, a Global System for Mobile communications (GSM) connection, or another type of cellular or wireless coupling. In this example, coupling 1024 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

Instructions 1010 may be transmitted or received over WAN 1032 using a transmission medium via a network interface device (e.g., a network interface component included in communication components 1040) and utilizing any one of several well-known transfer protocols (e.g., HTTP). Similarly, instructions 1010 may be transmitted or received using a transmission medium via coupling 1022 (e.g., a peer-to-peer coupling) to devices 1020. The term “transmission medium” includes any intangible medium that can store, encoding, or carrying instructions 1010 for execution by computing system 1000, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The examples illustrated herein are described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, components, engines, and data stores are somewhat arbitrary, and particular operations are illustrated in a context of specific illustrative configurations. Other allocations of functionality are envisioned and may fall within a scope of various examples of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples as represented by the appended claims. The specification and drawings are, accordingly, to be regarded in an illustrative rather than a restrictive sense.

1. A method, comprising:
receiving, by a computing system from a client device, image data including a machine code;
decoding, using at least one processor, the machine code to identify a user associated with the client device;
retrieving, using the at least one processor, a plurality of data sources associated with the user and a shared vehicle associated with the user;
extracting, using the at least one processor, a plurality of features from the plurality of data sources;
building a feature vector representing the plurality of features;
inputting the feature vector into a machine learner to generate a classification of the user; and
generating, using the at least one processor, a policy for the user based on the classification of the user,
wherein the user is not an owner of the shared vehicle, and the policy insures the user for a limited duration.

2. The method of claim 1, wherein the image data represents a driver's license of the user, and the machine code is a bar code.

3. The method of claim 1, wherein the plurality of data sources includes at least one of mobile sensor data, driver data, vehicle data, credit data, and social network data.

4. The method of claim 1, wherein the plurality of features includes at least one of a Boolean feature, a numeric feature, a date feature, a text feature, an image feature and an application-specific feature.

5. The method of claim 1, wherein the policy is a dynamic insurance policy.

6. The method of claim 1, comprising:
updating the feature vector based on changes to the plurality of data sources;
inputting the updated feature vector into the machine learner to generate an updated classification of the user; and
updating the policy for the user based on the updated classification.

7. A machine learning system automatically to generate a policy for a user of a shared vehicle, the system comprising:
a plurality of data sources;
a data pipeline, communicatively coupled to the plurality of data sources, to:
access the plurality of data sources and retrieve a plurality of data items associated with a user and a shared vehicle, the user not being the owner of the shared vehicle;
extract a plurality of features from the plurality of data items;
construct a feature vector representing the plurality of features;
using a machine learner, generating a classification associated with the user based on the feature vector; and
generate the policy for the user based on the classification, the policy insuring the vehicle for a limited duration.

8. The machine learning system of claim 7, wherein the data pipeline includes a unified processing framework, a data store, and data warehouse, the unified processing framework to retrieve the plurality of data items from the plurality of data sources, processes the plurality of data items to generate processed data items, and to store the processed data items in the data store, at least a portion of the processed data items being persisted to the data warehouse.

9. The machine learning system of claim 8, wherein the data pipeline includes a virtualization layer having a plurality of analytical tools accessible to retrieve the processed data stored in the data store.

10. The machine learning system of claim 8, wherein the data pipeline further includes an underwriting platform, coupled to access the data store, and generate underwriting data based on the processed data items stored in the data store.

11. The machine learning system of claim 8, wherein the data pipeline further includes a marketing platform, coupled to access the data store, and to generate marketing data based on the processed data items stored in the data store.

12. The machine learning system of claim 8, wherein the data pipeline further includes a policy management system, the policy management system to generate the policy for the user based on the classification.

13. The machine learning system of claim 7, wherein the machine learner generates the classification using a training phase and a labeling phase, the machine learner to receive labeled training data during the training phase, and to generate the classification of the user based on rules generated during the training phase and applied to the feature vector.

14. A non-transitory computer-readable storage medium, the computer-readable storage medium including instructions that when executed by a computer, cause the computer to:
receive, by a computing system from a client device, image data including a machine code;
decode, using at least one processor, the machine code to identify a user associated with the client device;
retrieve, using the at least one processor, a plurality of data sources associated with the user and a shared vehicle associated with the user;
extract, using the at least one processor, a plurality of features from the plurality of data sources;
build a feature vector representing the plurality of features;
inputting the feature vector into a machine learner to generate a classification of the user; and
generate, using the at least one processor, a policy for the user based on the classification of the user,
wherein the user is not an owner of the shared vehicle, and the policy insures the user for a limited duration.

15. The computer-readable storage medium of claim 14, wherein the image data represents a driver's license of the user, and the machine code is a bar code.

16. The computer-readable storage medium of claim 14, wherein the plurality of data sources includes at least one of mobile sensor data, driver data, vehicle data, credit data, and social network data.

17. The computer-readable storage medium of claim 14, wherein the plurality of features includes at least one of a Boolean feature, a numeric feature, a date feature a text feature, an image feature and an application-specific feature.

18. The computer-readable storage medium of claim 14, comprising:
update the feature vector based on changes to the plurality of data sources;
inputting the updated feature vector into the machine learner to generate an updated classification of the user; and
update the policy for the user based on the updated classification.

19. A computing apparatus, the computing apparatus comprising:
a processor; and
a memory storing instructions that, when executed by the processor, configure the apparatus to:
receive, by a computing system from a client device, image data including a machine code;
decode, using at least one processor, the machine code to identify a user associated with the client device;
retrieve, using the at least one processor, a plurality of data sources associated with the user and a shared vehicle associated with the user;
extract, using the at least one processor, a plurality of features from the plurality of data sources;
build a feature vector representing the plurality of features;
inputting the feature vector into a machine learner to generate a classification of the user; and
generate, using the at least one processor, a policy for the user based on the classification of the user,
wherein the user is not an owner of the shared vehicle, and the policy insures the user for a limited duration.

20. The computing apparatus of claim 19, wherein the image data represents a driver's license of the user, and the machine code is a bar code.
